(19) United States
(12) Patent Application Publication
(10) Pub. No.: US 2025/0183359 A1
(43) Pub. Date: Jun. 5, 2025

(54) CRYSTALLINE SULFIDE SOLID ELECTROLYTE AND METHOD FOR PRODUCING SAME

(71) Applicant: IDEMITSU KOSAN CO.,LTD., Tokyo (JP)

(72) Inventors: Yusuke ISEKI, Chiba-shi, Chiba (JP); Hiroaki YAMADA, Chiba-shi, Chiba (JP)

(73) Assignee: IDEMITSU KOSAN CO.,LTD., Tokyo (JP)

(21) Appl. No.: 18/842,985

(22) PCT Filed: Mar. 1, 2023
(86) PCT No.: PCT/JP2023/007580

§ 371 Date: Aug. 30, 2024

(30) Foreign Application Priority Data
Mar. 4, 2022 (JP) 2022-033859

(51) Int. Cl. H01M 10/0562

(52) U.S. Cl. CPC H01M 10/0562; H01M 2300/008

(57) ABSTRACT

Provided are: a crystalline sulfide solid electrolyte, which has an improved ionic conductivity while adopting a liquid phase method, contains predetermined atoms, has a diffraction peak in X-ray diffractometry using a predetermined CuKα ray, and has a thio-LISICON Region II-type crystal structure as a basic structure; and a method for producing a crystalline sulfide solid electrolyte, the method including mixing using predetermined complexing agents and an instant drying step.

### TECHNICAL FIELD

The present invention relates to a crystalline sulfide solid electrolyte and a method for producing the same.

### BACKGROUND ART

With rapid spread of information-related devices, communication devices, and so on, such as personal computers, video cameras, and mobile phones, in recent years, development of a battery that is utilized as a power source therefor is considered to be important. Heretofore, in batteries to be used for such an application, an electrolytic solution containing a flammable organic solvent has been used, but since the electrolytic solution is liquid and flammable, its safety relating to leakage, ignition, and the like is a concern when used in a battery. Especially in vehicle-mounted applications, high capacity and high output power are required, and a concern on safety of a battery using a conventional electrolytic solution increases more than ever. Therefore, development of a battery having a solid electrolyte layer in place of an electrolytic solution is being made in view of the fact that by making the battery fully solid, simplification of a safety device can be achieved without using a flammable organic solvent within the battery and the battery is excellent in production cost and productivity.

Methods for producing a solid electrolyte to be used for a solid electrolyte layer are roughly classified into a solid phase method and a liquid phase method. The liquid phase method includes a homogeneous method in which a solid electrolyte material is completely dissolved in a solvent, and a heterogeneous method in which a solid electrolyte material is not completely dissolved and is brought into a solid-liquid coexisting suspension. For example, in the liquid phase method, as the homogeneous method, a method in which a solid electrolyte is dissolved in a solvent and reprecipitated is known (see, for example, PTL 1), and as the heterogeneous method, a method in which a solid electrolyte raw material such as lithium sulfide is allowed to react in a solvent containing a polar aprotic solvent (see, for example, PTLs 2 and 3, and NPL 1). A method using two types of complexing agents is also known (PTL 4).

Then, as a drying method, a method of drying a slurry containing a solid electrolyte or a precursor thereof and a polar solvent by fluidized drying, or the like is also known (see, for example, PTL 5).

### CITATION LIST

### Patent Literature

PTL 1: JP 2014-191899 A
PTL 2: WO 2014/192309
PTL 3: WO 2018/054709
PTL 4: WO 2021/230189
PTL 5: WO 2021/230281

### Nonpatent Literature

NPL 1: “CHEMISTRY OF MATERIALS”, 2017, No. 29, pp. 1830-1835

### SUMMARY OF INVENTION

### Technical Problem

The present invention has been made in view of such circumstances, and provides a crystalline sulfide solid electrolyte with an improved ionic conductivity while adopting a liquid phase method.

### Solution to Problem

A crystalline sulfide solid electrolyte according to the present invention is a crystalline sulfide solid electrolyte,
containing a lithium atom, a phosphorus atom, a sulfur atom, and at least either one halogen atom of a bromine atom and an iodine atom, and
having a diffraction peak at 2θ=25.0±0.5° in X-ray diffractometry using a CuKα ray, and having a thio-LISICON Region II-type crystal structure as a basic structure.

Further, a method for producing a crystalline sulfide solid electrolyte according to the present invention is a method for producing a crystalline sulfide solid electrolyte, the method including:
first mixing of mixing a raw material-containing material containing a lithium atom, a phosphorus atom, a sulfur atom, and at least either one halogen atom of a bromine atom and an iodine atom with a complexing agent 1 in (1) below;
second mixing of subsequently mixing with a complexing agent 2 in (2) below; and
an instant drying step of drying by contact with a medium:
(1) a complexing agent 1 that is capable of forming Li₃PS₄ and a complex containing the halogen atom; and
(2) a complexing agent 2 that is other than the complexing agent 1 and is capable of forming a complex containing Li₃PS₄.

### Advantageous Effects of Invention

According to the present invention, it is possible to provide a crystalline sulfide solid electrolyte with an improved ionic conductivity while adopting a liquid phase method.

### BRIEF DESCRIPTION OF DRAWINGS

FIG. 1 is a flow diagram illustrating an example of a dryer (medium fluidized dryer) used in a production method of the present embodiment.

FIG. 2 is a flow diagram illustrating an example of a dryer (spray dryer) used in a production method of the present embodiment.

FIG. 3 shows X-ray diffraction spectra of crystalline sulfide solid electrolytes obtained in Examples and a powder obtained in Comparative Example.

FIG. 4 shows X-ray diffraction spectra of crystalline sulfide solid electrolytes obtained in Examples and a powder obtained in Comparative Example.

### DESCRIPTION OF EMBODIMENTS

An embodiment of the present invention (hereinafter sometimes referred to as “the present embodiment”) will be described below. In the present description, the upper limit and lower limit values relating to the numerical ranges accompanied with “or more”, “or less”, and “to” are numerical values that can be arbitrarily combined, and the values in Examples can also be used as the upper limit and lower limit values. Also, the rules that are considered preferable can be arbitrarily adopted. That is, one rule considered preferable can be adopted in combination with one or more other rules considered preferable. It can be said that a combination of preferred ones is more preferable.

### Findings that the Present Inventors have Acquired to Achieve the Present Invention

As a result of intensive and extensive studies for solving the above problem, the present inventors have found the following matters, and completed the present invention.

A liquid phase method is attracting attention for recent practical application of all-solid-state batteries. This is because a liquid phase method has the advantage of enabling synthesis simply in large amounts in addition to its versatility and applicability. On the other hand, since a solid electrolyte is dissolved, a liquid phase method has a problem that it is difficult to achieve a high ionic conductivity as compared with a solid phase method because some of the solid electrolyte components are decomposed, lost, or the like during precipitation. For example, in a homogenous method, since raw materials and a solid electrolyte are once completely dissolved, respective components such as the raw materials and the solid electrolyte can be uniformly dispersed in a liquid. However, in the subsequent precipitation step, precipitation proceeds according to the solubility specific to each component, and therefore it has been extremely difficult to precipitate the components while maintaining the dispersed state of the components. As a result, each component separates and precipitates. In addition, in the homogeneous method, the affinity between the solvent and lithium becomes too strong, and therefore the solvent is difficult to remove even if it is dried after precipitation. For these reasons, the homogenous method also has a problem that the ionic conductivity of the solid electrolyte is greatly reduced.

Further, also in the solid-liquid coexisting heterogeneous method, part of the solid electrolyte is dissolved, and therefore separation occurs due to the elution of a specific component, and there is a problem that it is difficult to obtain a desired solid electrolyte.

Under such circumstances, the present inventors focused on using two types of complexing agents having different properties. The two types are the following complexing agents 1 and 2.
(1) a complexing agent 1 that is capable of forming Li₃PS₄ and a complex containing the halogen atom
(2) a complexing agent 2 that is other than the complexing agent 1 and is capable of forming a complex containing Li₃PS₄

First, the complexing agent 1 having the properties described above is used to further form a complex containing a halogen atom while forming Li₃PS₄ to serve as a basic skeleton of a solid electrolyte by a reaction of a raw material-containing material containing solid electrolyte raw materials. This maintains a dispersed state of the solid electrolyte raw materials, and further Li₃PS₄, the complex containing a halogen atom, and the like in the complexing agent uniformly, and a fluid in which the solid electrolyte raw materials, and further Li₃PS₄, the complex containing a halogen atom, and the like are uniformly dispersed is obtained. Therefore, it was considered that when the fluid is then mixed with the complexing agent 2 and thereafter the complexing agents are removed, a precursor of a solid electrolyte (hereinafter, also referred to as “precursor of a solid electrolyte” or “electrolyte precursor”) is formed while each component is uniformly dispersed, and as a result, a crystalline sulfide solid electrolyte having a high ionic conductivity is obtained.

However, it was found that the formation reaction of Li₃PS₄ by the complexing agent 1 tends to stagnate after progressing to a certain extent. Therefore, the present inventors wondered if it would be possible to allow the formation reaction of Li₃PS₄ by the complexing agent 1 to proceed without stagnation by using the complexing agent 2 capable of forming a complex containing Li₃PS₄ after the reaction by the complexing agent 1 is started.

The present inventors also focused on a drying method when the complexing agents 1 and 2 are removed from the fluid containing Li₃PS₄, and further complexes such as a complex containing a halogen atom and a complex containing Li₃PS₄ obtained by mixing the solid electrolyte raw materials with the complexing agents 1 and 2.

While the advantage obtained by using the complexing agents is large, it has been found that a component that is easily eluted in the complexing agents is eluted from the solid electrolyte raw materials, Li₃PS₄ obtained by the reaction of the solid electrolyte raw materials, and further the complex containing a halogen atom, the complex containing Li₃PS₄, or the like. Then, it was found that the elution is due to the effect of heat applied during drying, and in particular, when drying is performed at a normal speed, the effect becomes greater. From this finding, it was discovered that as the drying method when the complexing agents 1 and 2 are removed from the fluid obtained through the first mixing and the second mixing, it is important to adopt instant drying for instantaneously removing the complexing agents from the fluid, and drying by contact with a medium is extremely excellent as the instant drying method.

Based on the above studies, it was found that a crystalline sulfide solid electrolyte with an improved ionic conductivity while adopting a liquid phase method is obtained by using the complexing agents 1 and 2 having specific properties and adopting instant drying of drying by contact with a medium as a drying method when the complexing agents 1 and 2 are removed.

In addition, the present inventors conducted studies on the structure of a crystalline sulfide solid electrolyte obtained by the above method using a raw material-containing material containing solid electrolyte raw materials blended in order to obtain a crystalline sulfide solid electrolyte having a thio-LISICON Region II-type crystal structure, and found that in X-ray diffractometry using a CuKα ray, a diffraction peak at 2θ=25.0±0.5°, which a crystalline sulfide solid electrolyte having a thio-LISICON Region II-type crystal structure should not originally have, is observed.

Representative examples of a halogen atom-containing crystalline sulfide solid electrolyte having a diffraction peak at 2θ=25.0±0.5° include a solid electrolyte having an argyrodite-type crystal structure.

Therefore, it is considered that the crystalline sulfide solid electrolyte obtained by the above method has a thio-LISICON Region II-type crystal structure as a basic structure, and has an argyrodite-type crystal structure in a part thereof.

### With Respect to Various Aspects of the Present Embodiment

The crystalline sulfide solid electrolyte according to a first aspect of the present embodiment is a crystalline sulfide solid electrolyte,
containing a lithium atom, a phosphorus atom, a sulfur atom, and at least either one halogen atom of a bromine atom and an iodine atom, and
having a diffraction peak at 2θ=25.0±0.5° in X-ray diffractometry using a CuKα ray, and having a thio-LISICON Region II-type crystal structure as a basic structure.

As described above, it is known that a diffraction peak at 2θ=25.0±0.5° is found in one having an argyrodite-type crystal structure, and a halogen atom is contained. It is considered that the crystal structure having a diffraction peak at 2θ=25.0±0.5°, that the crystalline sulfide solid electrolyte according to the present embodiment has, is specifically an argyrodite-type crystal structure containing at least either one halogen atom of a bromine atom and an iodine atom. A crystalline sulfide solid electrolyte having an argyrodite-type crystal structure is known to be a sulfide solid electrolyte having a high ionic conductivity in the same manner as a crystalline sulfide solid electrolyte having a thio-LISICON Region II-type crystal structure. Therefore, it is considered that the crystalline sulfide solid electrolyte of the present embodiment has a high ionic conductivity.

Although the reason why the crystalline sulfide solid electrolyte according to the present embodiment has a thio-LISICON Region II-type crystal structure as a basic structure, and has an argyrodite-type crystal structure in a part thereof is not clear, it is thought to be as follows.

When a reaction of a raw material-containing material containing solid electrolyte raw materials including a lithium atom, a phosphorus atom, a sulfur atom, and at least either one halogen atom of a bromine atom and an iodine atom is allowed to proceed, for example typically, in the case of using lithium sulfide, diphosphorus pentasulfide, and a lithium halide as a raw material containing a halogen atom, each raw material may exist locally depending on the state of mixing of these solid electrolyte raw materials. At this time, if lithium sulfide exists locally, the remaining lithium halide and Li₃PS₄ produced by the reaction of lithium sulfide and diphosphorus pentasulfide react due to the progression of the following reaction formula (1), and argyrodite formation more easily proceeds. Then, local presence of each raw material is extremely likely to occur particularly in the preparation of a sulfide solid electrolyte by a liquid phase method (heterogeneous system).

Li₃PS₄+Li₂S+LiX→Li₆PS₅X (1)
(X: a halogen atom)

In this manner, the crystalline sulfide solid electrolyte of the present embodiment has a thio-LISICON Region II-type crystal structure as a basic structure, and has an argyrodite-type crystal structure in a part thereof, and is considered to have a diffraction peak at 2θ=25.0 0.5° due to the presence of the argyrodite-type crystal structure.

The sulfide solid electrolyte according to a second aspect of the present embodiment is configured not to contain a chlorine atom in the sulfide solid electrolyte of the first aspect.

As described above, the sulfide solid electrolyte of the present embodiment has a thio-LISICON Region II-type crystal structure as a basic structure, and has an argyrodite-type crystal structure containing at least either one atom of a bromine atom and an iodine atom as a halogen atom in a part thereof.

The sulfide solid electrolyte according to a third aspect of the present embodiment is configured such that, in the sulfide solid electrolyte of the first or second aspect,
the halogen atom includes an iodine atom, and
the sulfide solid electrolyte according to a fourth aspect is configured such that, in any one of the first to third aspects,
the halogen atom includes a bromine atom and an iodine atom.

As described above, the sulfide solid electrolyte of the present embodiment has a thio-LISICON Region II-type crystal structure as a basic structure, and can be a crystalline sulfide solid electrolyte with an improved ionic conductivity due to incorporation of an iodine atom as the halogen atom, and moreover, incorporation of a bromine atom and an iodine atom.

The sulfide solid electrolyte according to a fifth aspect of the present embodiment is configured such that, in the sulfide solid electrolyte of any one of the first to fourth aspects,
a half width Δ2θ_{25.0} of the diffraction peak at 2θ=25.0±0.5° is larger than a half width Δ2θ_{23.5} of the diffraction peak at 2θ=23.5±0.5°.

The sulfide solid electrolyte of the present embodiment has a thio-LISICON Region II-type crystal structure as a basic structure, and therefore has a diffraction peak derived from the thio-LISICON Region II-type crystal structure. In particular, in a relationship between the half width Δ2θ_{23.5} of the diffraction peak at 2θ=23.5±0.5° and the half width Δ2θ_{25.0} of the diffraction peak at 2θ=25.0±0.5° derived from a crystal structure similar to the argyrodite-type crystal structure, when the half width Δ2θ_{25.0} is larger than the half width Δ2θ_{23.5}, it becomes easier to obtain a high ionic conductivity due to the effect of the argyrodite-type crystal structure.

The method for producing a crystalline sulfide solid electrolyte according to a sixth aspect of the present embodiment is a method for producing a crystalline sulfide solid electrolyte, the method including:
first mixing of mixing a raw material-containing material containing a lithium atom, a phosphorus atom, a sulfur atom, and at least either one halogen atom of a bromine atom and an iodine atom with a complexing agent 1 in (1) below;
second mixing of subsequently mixing with a complexing agent 2 in (2) below; and
an instant drying step of drying by contact with a medium.
(1) a complexing agent 1 that is capable of forming Li₃PS₄ and a complex containing the halogen atom
(2) a complexing agent 2 that is other than the complexing agent 1 and is capable of forming a complex containing Li₃PS₄

As described above, by adopting the above complexing agents 1 and 2 as two types of complexing agents, the formation reaction of Li₃PS₄ is allowed to proceed without stagnation, and also a dispersed state of the solid electrolyte raw materials, and further Li₃PS₄, the complex containing the halogen atom, and the like is maintained uniformly. Therefore, a fluid obtained through the first mixing and the second mixing becomes a fluid in which Li₃PS₄ and complexes such as the complex containing a halogen atom and the complex containing Li₃PS₄ are uniformly dispersed, and a precursor of a solid electrolyte obtained by removing the complexing agents from the fluid also becomes uniform. Examples of an adverse effect of using the complexing agents include a case where the ionic conductivity may decrease due to elution of a component that is easily eluted in the complexing agents from the complexes or the like contained in the fluid. Therefore, as the drying method when the complexing agents 1 and 2 are removed, instant drying of drying by contact with a medium is adopted in order to instantaneously remove the complexing agents from the fluid obtained through the first mixing and the second mixing and containing the complexes and the complexing agents.

As a result, according to the production method of the present embodiment, a crystalline sulfide solid electrolyte having a high ionic conductivity is obtained.

The method for producing a crystalline sulfide solid electrolyte according to a seventh aspect of the present embodiment is configured such that, in the sixth aspect,
the drying by contact with a medium is performed by at least one drying selected from fluidized drying using media particles as the medium, drying with a spray dryer, and airflow drying.

By performing the drying by contact with a medium through such drying, instant drying can be more easily achieved.

The method for producing a crystalline sulfide solid electrolyte according to an eighth aspect of the present embodiment is configured such that, in the sixth or seventh aspect,
the complexing agent 1 is a solvent containing a nitrogen atom, and
the method for producing a crystalline sulfide solid electrolyte according to a ninth aspect is configured such that, in any one of the sixth to eighth aspects,
the complexing agent 2 is a solvent containing an oxygen atom.

As described above, according to the production method of the present embodiment, by adopting two types of complexing agents, namely, the complexing agents 1 and 2, the formation reaction of Li₃PS₄ is allowed to proceed without stagnation, and also a dispersed state of the solid electrolyte raw materials, and further Li₃PS₄, the complex containing the halogen atom, and the like is maintained uniformly. Therefore, a fluid obtained through the first mixing and the second mixing becomes a fluid in which Li₃PS₄ and complexes such as the complex containing a halogen atom and the complex containing Li₃PS₄ are uniformly dispersed, and a precursor of a solid electrolyte obtained by removing the complexing agents from the fluid also becomes uniform. As a result, a crystalline sulfide solid electrolyte having a high ionic conductivity is obtained.

A solvent containing a nitrogen atom is suitable as the complexing agent 1 because it is likely to exhibit the property of being able to form Li₃PS₄ and a complex containing the halogen atom of the complexing agent 1, and it becomes easier to distinguish from the property of the complexing agent 2 that the complexing agent 2 is other than the complexing agent 1 and is capable of forming a complex containing Li₃PS₄.

Further, a solvent containing an oxygen atom is suitable as the complexing agent 2 because it is likely to exhibit the property of the the complexing agent 2 of being able to form a complex containing Li₃PS₄ and being other than the complexing agent 1, and also it is less likely to form a complex containing a halogen atom as compared with the complexing agent 1.

The method for producing a crystalline sulfide solid electrolyte according to a tenth aspect of the present embodiment is configured such that, in any one of the sixth to ninth aspects,
a number of moles of the amount of the complexing agent 1 used with respect to a total number of moles of lithium atoms contained in the raw material-containing material is 0.1 or more and 2.0 or less, and
the method for producing a crystalline sulfide solid electrolyte according to an eleventh aspect is configured such that, in any one of the sixth to tenth aspects,
a number of moles of the amount of the complexing agent 2 used with respect to a total number of moles of Li₃PS₄ produced from the raw material-containing material is 0.1 or more and 5.0 or less.

The tenth aspect and the eleventh aspect define preferred amounts of the complexing agents 1 and 2 used in any one of the sixth to ninth aspects and any one of the sixth to tenth aspects, respectively. When the amounts of the complexing agents used are within the above ranges, the effect of using the complexing agents is more efficiently obtained.

The method for producing a crystalline sulfide solid electrolyte according to a twelfth aspect of the present embodiment is configured such that, in any one of the sixth to eleventh aspects,
the raw material-containing material contains lithium sulfide and diphosphorus pentasulfide, and
the method for producing a crystalline sulfide solid electrolyte according to a thirteenth aspect of the present embodiment is configured such that, in any one of the sixth to twelfth aspects,
the raw material-containing material contains at least one type selected from bromine, iodine, lithium bromide, and lithium iodide.

The twelfth aspect and the thirteenth aspect specify preferred raw materials as the solid electrolyte raw materials contained in the raw material-containing material. When lithium sulfide and diphosphorus pentasulfide are used as the solid electrolyte raw materials, the formation reaction of Li₃PS₄ due to the use of the complexing agents 1 and 2 more easily proceeds properly. Further, bromine, iodine, lithium bromide, and lithium iodide easily supply a bromine atom and an iodine atom as halogen atoms, and therefore are suitable as solid electrolyte raw materials.

The method for producing a crystalline sulfide solid electrolyte according to a fourteenth aspect of the present embodiment is configured such that, in any one of the sixth to thirteenth aspects,
the crystalline sulfide solid electrolyte contains a lithium atom, a phosphorus atom, a sulfur atom, and at least either one halogen atom of a bromine atom and an iodine atom, has a diffraction peak at 2θ=25.0±0.5° in X-ray diffractometry using a CuKα ray, and has a thio-LISICON Region II-type crystal structure as a basic structure.

This means that the crystalline sulfide solid electrolyte of the present embodiment is easily obtained by the method for producing a crystalline sulfide solid electrolyte of the present embodiment.

Hereinafter, the crystalline sulfide solid electrolyte of the present embodiment will be described in more detail in accordance with the above embodiment.

In the present description, the “solid electrolyte” means an electrolyte that maintains a solid state at 25° C. in a nitrogen atmosphere. The sulfide solid electrolyte in the present embodiment is a solid electrolyte that contains a lithium atom, a phosphorus atom, a sulfur atom, and at least either one halogen atom of a bromine atom and an iodine atom, uses a lithium atom as a conductive species, and has an ionic conductivity attributable to the lithium atom.

The “sulfide solid electrolyte” encompasses both of a crystalline sulfide solid electrolyte having a crystal structure according to the present embodiment and an amorphous sulfide solid electrolyte.

In the present description, the crystalline sulfide solid electrolyte is a sulfide solid electrolyte that has a peak derived from a sulfide solid electrolyte observed in an X-ray diffraction pattern in X-ray diffractometry regardless of the presence or absence of a peak derived from a raw material of the sulfide solid electrolyte therein. In other words, the crystalline sulfide solid electrolyte contains a crystal structure derived from a sulfide solid electrolyte, and a part thereof may have a crystal structure derived from the sulfide solid electrolyte or the whole thereof may have a crystal structure derived from the sulfide solid electrolyte. The crystalline sulfide solid electrolyte may contain an amorphous sulfide solid electrolyte in a part thereof as long as it has such an X-ray diffraction pattern as above. Accordingly, the crystalline sulfide solid electrolyte encompasses a so-called glass ceramic which is obtained by heating an amorphous sulfide solid electrolyte to the crystallization temperature or higher.

In the present description, the amorphous sulfide solid electrolyte means one having a halo pattern in which a peak other than the peaks derived from the materials is not substantially observed in an X-ray diffraction pattern in X-ray diffractometry regardless of the presence or absence of a peak derived from a raw material of the sulfide solid electrolyte.

### (Crystalline Sulfide Solid Electrolyte)

The crystalline sulfide solid electrolyte of the present embodiment is a crystalline sulfide solid electrolyte
containing a lithium atom, a phosphorus atom, a sulfur atom, and at least either one halogen atom of a bromine atom and an iodine atom, and
having a diffraction peak at 2θ=25.0±0.5° in X-ray diffractometry using a CuKα ray, and having a thio-LISICON Region II-type crystal structure as a basic structure.

### (Thio-LISICON Region II-Type Crystal Structure)

The crystalline sulfide solid electrolyte of the present embodiment has a thio-LISICON Region II-type crystal structure as a basic structure. The “basic structure” means a main crystal structure, and more specifically means that the proportion of the thio-LISICON Region II-type crystal structure in the total crystals is 80.0% or more. The proportion of the thio-LISICON Region II-type crystal structure in the total crystals of the crystalline sulfide solid electrolyte of the present embodiment is preferably 90.0% or more, more preferably 95.0% or more, and still more preferably 96.0% or more.

The proportion of the thio-LISICON Region II-type crystal structure in the total crystals is defined as the proportion of the total area of each peak of the thio-LISICON Region II-type crystal structure (peaks: 77 to 79 ppm, 89 to 91 ppm) to the total area in an NMR (solid ³¹P NMR) spectrum by solid ³¹P-NMR measurement. As a method for solid ³¹P-NMR measurement, a conventional method may be followed, for example, measurement may be performed under the following conditions using a nuclear magnetic resonance apparatus.
Observed nucleus: ³¹P
Resonance frequency: 400 MHz
Magnetic field: 9.4 T
Probe: 4 mm Mas probe
MAS speed: 15 kMz
Measurement temperature: room temperature (23° C.)
n/2 Pulse width: 3.11 μs
Number of integrations: 32
Range of measurement: 350 ppm to −250 ppm
Reference: 85% H₃PO₄

Representative examples of the thio-LISICON Region II-type crystal structure include an Li₄₋ₓGe₁₋ₓPₓS₄-based thio-LISICON Region II-type crystal structure (see Kanno, et al., Journal of The Electrochemical Society, 148 (7) A742-746 (2001)) and a crystal structure similar to a Li₄₋ₓGe₁₋ₓPₓS₄-based thio-LISICON Region II-type crystal structure (see Solid State Ionics, 177 (2006), 2721-2725).

The diffraction peaks of the Li₄₋ₓGe₁₋ₓPₓS₄-based thio-LISICON Region II-type crystal structure appear, for example, at around 2θ=20.1°, 23.9°, and 29.5°. The diffraction peaks of the crystal structure similar to the Li₄₋ₓGe₁₋ₓPₓS₄-based thio-LISICON Region II-type crystal structure appear, for example, at around 2θ=20.2 and 23.6°. The positions of these peaks may vary within a range of 0.5°.

In this manner, the crystalline sulfide solid electrolyte having a thio-LISICON Region II-type crystal structure does not have a diffraction peak at 2θ=25.0±0.5°. Therefore, as described above, the crystalline sulfide solid electrolyte of the present embodiment is considered to have a thio-LISICON Region II-type crystal structure and also have an argyrodite-type crystal structure as another crystal structure.

Further, the crystalline sulfide solid electrolyte of the present embodiment preferably does not contain crystalline Li₃PS₄ (β-Li₃PS₄). That is, it preferably does not have diffraction peaks at 2θ=17.5° and 26.10 that are observed in crystalline Li₃PS₄. This is because when crystalline Li₃PS₄ (β-Li₃PS₄) is contained, the ionic conductivity decreases.

### (Atoms Forming Crystalline Sulfide Solid Electrolyte)

In the crystalline sulfide solid electrolyte of the present embodiment, as the atoms forming this, it is only necessary to contain a lithium atom, a phosphorus atom, a sulfur atom, and at least either one halogen atom of a bromine atom and an iodine atom described above, and it is preferable to contain a bromine atom and an iodine atom as the halogen atom at the same time from the viewpoint of improving the ionic conductivity.

Further, it is preferable that a chlorine atom is not contained as the halogen atom. This is because, as described above, when the crystalline sulfide solid electrolyte of the present embodiment has an argyrodite-type crystal structure having at least either one atom of a bromine atom and an iodine atom as the halogen atom, a high ionic conductivity is obtained.

As for the proportions of a lithium atom, a phosphorus atom, a sulfur atom, and at least either one halogen atom of a bromine atom and an iodine atom contained in the crystalline sulfide solid electrolyte of the present embodiment, the blending ratio (molar ratio) of a lithium atom: a phosphorus atom: a sulfur atom: the total halogen atoms is preferably 1.0 to 1.8:0.1 to 0.8:1.0 to 2.0:0.01 to 0.8, more preferably 1.1 to 1.7:0.2 to 0.6:1.2 to 1.9:0.05 to 0.7, and still more preferably 1.2 to 1.6:0.25 to 0.5:1.3 to 1.8:0.08 to 0.6.

When a bromine atom and an iodine atom are used in combination as the halogen atom, the blending ratio (molar ratio) of a lithium atom: a phosphorus atom: a sulfur atom: a bromine atom: an iodine atom is preferably 1.0 to 1.8:0.1 to 0.8:1.0 to 2.0:0.01 to 0.4:0.01 to 0.4, more preferably 1.1 to 1.7:0.2 to 0.6:1.2 to 1.9:0.02 to 0.35:0.02 to 0.35, still more preferably 1.2 to 1.6:0.25 to 0.5:1.3 to 1.8:0.03 to 0.3:0.03 to 0.3, and even more preferably 1.3 to 1.55:0.3 to 0.5:1.4 to 1.8:0.05 to 0.2:0.05 to 0.2.

When the the blending ratio (molar ratio) of a lithium atom, a phosphorus atom, a sulfur atom, and a halogen atom is set within the above range, it becomes easier to obtain a crystalline sulfide solid electrolyte having a higher ionic conductivity.

### (Diffraction Peak at 2θ=25.0±0.5°)

The crystalline sulfide solid electrolyte of the present embodiment has a diffraction peak at 2θ=25.0±0.5° in X-ray diffractometry using a CuKα ray. As described above, the diffraction peak at 2θ=25.0±0.5° is considered to be derived from an argyrodite-type crystal structure.

The argyrodite-type crystal structure is a crystal structure, which basically has a structural skeleton of Li₇PS₆, and in which P is partially substituted with Si.

Examples of the compositional formula of the argyrodite-type crystal structure include Li₇₋ₓP_{1-y}Si_{y}S₆ and Li₇₊ₓP_{1-y}Si_{y}S₆ (x is −0.6 to 0.6, and y is 0.1 to 0.6). The argyrodite-type crystal structure represented by such a compositional formula is a cubic crystal or an orthorhombic crystal, and preferably a cubic crystal, and has peaks mainly appearing at positions of 2θ=15.5°, 18.0°, 25.0°, 30.0°, 31.4°, 45.3°, 47.0°, and 52.0° in X-ray diffractometry using a CuKα ray.

Examples of the compositional formula of the argyrodite-type crystal structure include Li_{7-x-2y}PS_{6-x-y}Clₓ (0.8≤x≤1.7, 0≤y≤−0.25x+0.5). The argyrodite-type crystal structure represented by the compositional formula is preferably a cubic crystal, and has peaks mainly appearing at positions of 20=15.5°, 18.0°, 25.0°, 30.0°, 31.4°, 45.3°, 47.0°, and 52.0° in X-ray diffractometry using a CuKα ray.

Examples of the compositional formula of the argyrodite-type crystal structure also include Li₇₋ₓPS₆₋ₓHaₓ (Ha is Cl or Br, x is preferably 0.2 to 1.8). The argyrodite-type crystal structure represented by the compositional formula is preferably a cubic crystal, and has peaks mainly appearing at positions of 20=15.5°, 18.0°, 25.0°, 30.0°, 31.4°, 45.3°, 47.0°, and 52.0° in X-ray diffractometry using a CuKα ray.

In this manner, the argyrodite-type crystal structure has a diffraction peak at 2θ=25.0°. The argyrodite-type crystal structure of the crystalline sulfide solid electrolyte of the present embodiment has a halogen atom, and therefore is considered to have a structure of either Li_{7-x-2y}PS_{6-x-y}Clₓ (0.8≤x≤1.7, 0<y≤−0.25x+0.5) containing a chlorine atom or Li_{7X}PS₆₋ₓHaₓ (Ha is Cl or Br, x is preferably 0.2 to 1.8).

In the crystalline sulfide solid electrolyte of the present embodiment, it is preferable that a half width Δ2θ_{25.0} of the diffraction peak at 2θ=25.0±0.5° derived from the argyrodite-type crystal structure is larger than a half width Δ2θ_{23.5} of the diffraction peak at 2θ=23.5±0.5° derived from the thio-LISICON Region II-type crystal structure. When the half width Δ2θ_{25.0} is larger than the half width Δ2θ_{23.5}, it becomes easier to obtain a high ionic conductivity due to the effect of the argyrodite-type crystal structure in the crystalline sulfide solid electrolyte of the present embodiment.

For similar reasons, the half width Δ2θ_{25.0} of the diffraction peak at 2θ=25.0±0.5° derived from the argyrodite-type crystal structure is preferably 0.3° or more, more preferably 0.5° or more, and still more preferably 0.8° or more, and the upper limit is preferably 1.5° or less, more preferably 1.4° or less, and still more preferably 1.25° or less.

The ratio between Δ2θ_{25.0} and Δ2θ_{23.5}, (Δ2θ_{25.0}/Δ2θ_{23.5}) is preferably 1.1 or more, more preferably 1.4 or more, still more preferably 1.7 or more, and even more preferably 1.85 or more, and the upper limit is preferably 2.5 or less, more preferably 2.4 or less, still more preferably 2.2 or less, and even more preferably 2.05 or less.

In the present description, the half-width is a numerical value determined as follows.

A range of the maximum peak (diffraction peak) of interest±2° is used. A proportion of Lorentz function is represented by A (0≤A≤1), a corrected peak intensity value is represented by B, a maximum peak at 20 is represented by C, a peak position in a range (C±2°) to be used for calculation is represented by D, a half width is represented by E, a background is represented by F, and each peak intensity in the peak range to be used for calculation is represented by G, and the following calculation is performed at each peak position when the variables are A, B, C, D, E, and F.

$$H = G - \{ B \times \{ A / ( 1 + {( D - C )}^{2} / {E}^{2} ) + ( 1 - A ) \times exp ( - 1 \times {( D - C )}^{2} / {E}^{2} ) \} + F \}$$

H's are summed within the range of the peak C±2° to be calculated, and the half width can be determined by GRG nonlinear minimization of the sum with the Solver function of a spreadsheet software Excel (Microsoft Corporation).

Further, the intensity ratio (I_{25.0}/I_{23.5}) between the intensity of the diffraction peak at 2θ=23.5±0.5° (I_{23.5}) and the intensity of the diffraction peak at 2θ=25.0±0.5° (I_{25.0}) is preferably 0.01 or more, more preferably 0.025 or more, and still more preferably 0.04 or more, and the upper limit is preferably 0.1 or less, more preferably is 0.085 or less, and still more preferably 0.06 or less. When the peak intensity of the diffraction peak is within the above range, it becomes easier to obtain a high ionic conductivity due to the effect of the argyrodite-type crystal structure.

The proportion of the argyrodite-type crystal structure in the total crystals of the crystalline sulfide solid electrolyte of the present embodiment is preferably 5.0% or less, and the lower limit is preferably 0.01% or more. When the proportion of the argyrodite-type crystal structure is within the above range, it becomes easier to obtain a high ionic conductivity due to the effect of the argyrodite-type crystal structure.

The shape of the crystalline sulfide solid electrolyte of the present embodiment is not particularly limited, and an example thereof include a particulate shape.

The average particle diameter (D₅₀) of the sulfide solid electrolyte in a particulate shape can be, for example, within the range of 0.01 μm to 500 μm or 0.1 to 200 μm. In the present description, the average particle diameter (D₅₀) is a particle diameter to reach 50% of all of the particles in sequential cumulation from particles of the smallest particle diameter when a particle size distribution cumulative curve is drawn, and the volume distribution is an average particle diameter which can be measured, for example, using a laser diffraction/scattering particle size distribution analyzer.

### [Method for Producing Crystalline Sulfide Solid Electrolyte]

The method for producing a crystalline sulfide solid electrolyte of the present embodiment includes:
first mixing of mixing a raw material-containing material containing a lithium atom, a phosphorus atom, a sulfur atom, and at least either one halogen atom of a bromine atom and an iodine atom with a complexing agent 1 in (1) below;
second mixing of subsequently mixing with a complexing agent 2 in (2) below; and
an instant drying step of drying by contact with a medium.

### (Raw Material-Containing Material)

The raw material-containing material used in the present embodiment contains a lithium atom, a phosphorus atom, a sulfur atom, and at least either one halogen atom of a bromine atom and an iodine atom, and preferably contains two or more types of solid electrolyte raw materials (compounds) containing at least one or more types of atoms selected from these atoms.

Representative examples of the solid electrolyte raw materials (compounds) contained in the raw material-containing material include a raw material containing at least two types of atoms selected from the above-mentioned four or five types of atoms, for example, lithium sulfide; lithium halides such as lithium fluoride, lithium chloride, lithium bromide, and lithium iodide; phosphorous sulfides such as diphosphorus trisulfide (P₂S₃) and diphosphorus pentasulfide (P₂S₅); phosphorus halides such as various phosphorus fluorides (PF₃ and PF₅), various phosphorus chlorides (PCl₃, PCl₅, and P₂Cl₄), various phosphorus bromides (PBr₃ and PBrs), and various phosphorus iodides (PI₃ and P₂I₄); thiophosphoryl halides such as thiophosphoryl fluoride (PSF3), thiophosphoryl chloride (PSCl₃), thiophosphoryl bromide (PSBr₃), thiophosphoryl iodide (PSI₃), thiophosphoryl dichloride fluoride (PSCl₂F), and thiophosphoryl dibromide fluoride (PSBr₂F); and the like, as well as halogen simple substances such as fluorine (F₂), chlorine (Cl₂), bromine (Br₂), and iodine (I₂), preferably bromine (Br₂) and iodine (I₂).

Examples of a raw material which may be used as the raw material other than those described above include a raw material containing at least one type of atom selected from the above-mentioned four or five types of atoms, and also containing an atom other than the four or five types of atoms, and specific examples thereof include lithium compounds such as lithium oxide, lithium hydroxide, and lithium carbonate; alkali metal sulfides such as sodium sulfide, potassium sulfide, rubidium sulfide, and cesium sulfide; metal sulfides such as silicon sulfide, germanium sulfide, boron sulfide, gallium sulfide, tin sulfide (SnS and SnS₂), aluminum sulfide, and zinc sulfide; phosphoric acid compounds such as sodium phosphate and lithium phosphate; halide compounds of an alkali metal other than lithium, for example, sodium halides such as sodium iodide, sodium fluoride, sodium chloride, and sodium bromide; metal halides such as an aluminum halide, a silicon halide, a germanium halide, an arsenic halide, a selenium halide, a tin halide, an antimony halide, a tellurium halide, and a bismuth halide; and phosphorus oxyhalides such as phosphorus oxychloride (POCl₃) and phosphorus oxybromide (POBr₃).

Among them, lithium sulfide; phosphorus sulfides such as diphosphorus trifluoride (P₂S₃) and diphosphorus pentasulfide (P₂S₅); halogen simple substances such as fluorine (F₂), chlorine (Cl₂), bromine (Br₂), and iodine (I₂); and lithium halides such as lithium fluoride, lithium chloride, lithium bromide, and lithium iodide are preferable. In addition, when an oxygen atom is introduced into a solid electrolyte, lithium oxide, lithium hydroxide, and a phosphoric acid compound such as lithium phosphate are preferable.

Preferred examples of a combination of raw materials include a combination of lithium sulfide, diphosphorus pentasulfide, and a lithium halide, and a combination of lithium sulfide, diphosphorus pentasulfide, and a halogen simple substance, and as the lithium halide, lithium bromide or lithium iodide is preferable, and as the halogen simple substance, bromine or iodine is preferable.

Further, for example, it is also possible to use a halogen simple substance as a raw material, and allow the halogen simple substance and lithium sulfide to react with each other to form a lithium halide, which is then allowed to further react with lithium sulfide and diphosphorus pentasulfide.

In the present embodiment, Li₃PS₄ containing a PS₄ structure can also be used as part of the raw material. Specifically, first Li₃PS₄ is prepared by production or the like, and is used as a raw material.

The content of Li₃PS₄ with respect to the total raw material is preferably 60 to 100 mol %, more preferably 65 to 90 mol %, and still more preferably 70 to 80 mol %.

When Li₃PS₄ and a halogen simple substance are used, the content of the halogen simple substance with respect to Li₃PS₄ is preferably 1 to 50 mol %, more preferably 10 to 40 mol %, still more preferably 20 to 30 mol %, and even more preferably 22 to 28 mol %.

The lithium sulfide used in the present embodiment is preferably in the form of particles.

The average particle diameter (D₅₀) of the lithium sulfide particles is preferably 0.1 μm or more and 1,000 μm or less, more preferably 0.5 μm or more and 100 μm or less, and still more preferably 1 μm or more and 20 μm or less. Further, among the solid raw materials exemplified as the raw material above, a solid raw material having an average particle diameter equivalent to that of the lithium sulfide particles is preferable, that is, a solid raw material having an average particle diameter within the same range as the lithium sulfide particles is preferable.

When lithium sulfide, diphosphorus pentasulfide, and a lithium halide are used as the raw materials, the ratio of lithium sulfide to the total of lithium sulfide and diphosphorus pentasulfide is preferably 70 to 80 mol %, more preferably 72 to 78 mol %, and still more preferably 74 to 78 mol % from the viewpoint of obtaining higher chemical stability and a higher ionic conductivity.

When lithium sulfide, diphosphorus pentasulfide, a lithium halide, and another raw material to be used as necessary are used, the content of lithium sulfide and diphosphorus pentasulfide with respect to the total of these materials is preferably 60 to 95 mol %, more preferably 65 to 90 mol %, and still more preferably 70 to 85 mol %.

Further, when lithium bromide and lithium iodide are used in combination as the lithium halide, the ratio of lithium bromide to the total of lithium bromide and lithium iodide is preferably 1 to 99 mol %, more preferably 20 to 90 mol %, still more preferably 40 to 80 mol %, and even more preferably 45 to 70 mol % from the viewpoint of improving the ionic conductivity.

When a halogen simple substance is used as a raw material, and lithium sulfide and diphosphorus pentasulfide are used, the ratio of the number of moles of lithium sulfide excluding the same number of moles of lithium sulfide as the number of moles of the halogen simple substance to the total number of moles of lithium sulfide and diphosphorus pentasulfide excluding the same number of moles of lithium sulfide as the number of moles of the halogen simple substance is preferably within the range of 60 to 90%, more preferably within the range of 65 to 85%, still more preferably within the range of 68 to 82%, even more preferably within the range of 72 to 78%, and particularly preferably within the range of 73 to 77%. This is because when the ratio is within these ranges, a higher ionic conductivity is obtained.

In addition, from a similar viewpoint, when lithium sulfide, diphosphorus pentasulfide, and a halogen simple substance are used, the content of the halogen simple substance with respect to the total amount of lithium sulfide, diphosphorus pentasulfide, and the halogen simple substance is preferably 1 to 50 mol %, more preferably 2 to 40 mol %, still more preferably 3 to 25 mol %, and even more preferably 3 to 15 mol %.

When lithium sulfide, diphosphorus pentasulfide, a halogen simple substance, and a lithium halide are used, the content of the halogen simple substance (a mol %) and the content of the lithium halide (P mol %) with respect to the total amount of these preferably satisfy the following formula (2), more preferably satisfy the following formula (3), still more preferably satisfy the following formula (4), and even more preferably satisfy the following formula (5).

$$2 \leq 2 α + β \leq 100 \qquad ( 2 )$$

$$4 \leq 2 α + β \leq 80 \qquad ( 3 )$$

$$6 \leq 2 α + β \leq 50 \qquad ( 4 )$$

$$6 \leq 2 α + β \leq 30 \qquad ( 5 )$$

In addition, in a case where two types of halogen simple substances, that is, bromine and iodine are used, when the number of moles of bromine is represented by B1 and the number of moles of iodine is represented by B2, B1:B2 is preferably 1 to 99:99 to 1, more preferably 15:85 to 90:10, still more preferably 20:80 to 80:20, even more preferably 30:70 to 75:25, and particularly preferably 35:65 to 75:25.

(Complexing Agent 1 that Satisfies (1))

The complexing agent 1 used in the production method of the present embodiment is a complexing agent that satisfies the above-mentioned (1), that is, a complexing agent that is capable of forming Li₃PS₄ and a complex containing a halogen atom to be obtained from Li₂S and P₂S₅, which are preferably used as solid electrolyte raw materials, and another solid electrolyte raw material containing a halogen atom.

As the complexing agent 1, any material can be used without any particular limitations as long as it has the above-mentioned performance, and a compound containing an atom having particularly high affinity for a lithium atom, for example, a heteroatom such as a nitrogen atom, an oxygen atom, or a chlorine atom is preferable, and a compound having a group containing such a heteroatom is more preferable. This is because these heteroatoms and a group containing such a heteroatom can coordinate with (bind to) a lithium atom.

The heteroatom present in the molecule of the complexing agent 1 has high affinity for a lithium atom, and is considered to have an ability to easily form a complex by binding to Li₃PS₄ containing a PS₄ structure to serve as the main skeleton of the thio-LISICON Region II-type crystal structure to serve as the basic structure of the crystalline sulfide solid electrolyte to be produced according to the present embodiment, and a solid electrolyte raw material containing a lithium atom and a halogen atom such as a lithium halide. In the first mixing, Li₃PS₄ and a complex containing a halogen atom are formed by mixing the solid electrolyte raw materials and the complexing agent 1, and further a complex containing Li₃PS₄ is formed by the second mixing with the complexing agent 2, which will be described later, so that the dispersed state of each component can be maintained well. Then, the complexing agents are removed from the fluid obtained through the first mixing and the second mixing to obtain an electrolyte precursor in which a halogen atom is more uniformly dispersed and fixed, and therefore it is considered that a solid electrolyte having a high ionic conductivity is obtained.

The fact that the complexing agent 1 can form Li₃PS₄ and a complex containing a halogen atom can be directly checked, for example, by an infrared absorption spectrum measured by an FT-IR analysis (diffuse reflection method).

For example, in Examples, by analyzing a powder obtained by stirring the complexing agent 1 (tetramethylethylenediamine, hereinafter also simply referred to as “TMEDA”) and lithium iodide (LiI), and the complexing agent 1 itself by FT-IR analysis (diffuse reflection method), it can be verified that the spectrum of the powder obtained by stirring the complexing agent 1 and lithium iodide is different from the spectrum of TMEDA itself, especially in the peak derived from the C—N stretching vibration at 1,000 to 1,250 cm⁻¹. Further, it is known that a LiI-TMEDA complex is formed by stirring and mixing TMEDA and lithium iodide (for example, Aust. J. Chem., 1988, 41, 1925-34, especially FIG. 2 or the like), and therefore it is considered that a LiI-TMEDA complex is formed.

On the other hand, by also analyzing a powder obtained by stirring the complexing agent 1 (tetramethylethylenediamine, TMEDA) and Li₃PS₄ by FT-IR analysis (diffuse reflection method) in the same manner as described above, it can be verified that the spectrum of the powder is different from the spectrum of TMEDA itself in the peak derived from the C—N stretching vibration at 1,000 to 1,250 cm⁻¹, but meanwhile it can also be verified that the spectrum is similar to that of the LiI-TMEDA complex. From this, it is considered that a Li₃PS₄-TMEDA complex is formed.

In this manner, the above (1) that the complexing agent 1 satisfies, that is, the property capable of forming Li₃PS₄ and a complex containing a halogen atom is a property that can be specifically checked, for example, by FT-IR analysis (diffuse reflection method) or the like.

Therefore, the complexing agent 1 preferably has at least two heteroatoms capable of coordination (bonding) in the molecule, and more preferably has a group containing at least two heteroatoms in the molecule. When a group containing at least two heteroatoms in the molecule is contained, Li₃PS₄ and a solid electrolyte raw material containing a lithium atom and a halogen atom such as a lithium halide can be bonded via at least two heteroatoms in the molecule. Further, among the heteroatoms, a nitrogen atom is preferable, and as a group containing a nitrogen atom, an amino group is preferable. That is, an amine compound is preferable as the complexing agent.

The amine compound is not particularly limited as long as it has an amino group in the molecule so that the complex formation can be promoted, but a compound having at least two amino groups in the molecule is preferable. With such a structure, Li₃PS₄ and a solid electrolyte raw material containing a lithium atom and a halogen atom such as a lithium halide can be bonded via at least two nitrogen atoms in the molecule.

Examples of such an amine compound include amine compounds such as an aliphatic amine, an alicyclic amine, a heterocyclic amine, and an aromatic amine, and these can be used alone or multiple types thereof can be used in combination.

More specifically, representative preferred examples of the aliphatic amine include aliphatic diamines, for example, aliphatic primary diamines such as ethylenediamine, diaminopropane, and diaminobutane; aliphatic secondary diamines such as N,N′-dimethylethylenediamine, N,N′-diethylethylenediamine, N,N′-dimethyldiaminopropane, and N,N′-diethyldiaminopropane; aliphatic tertiary diamines such as N,N,N′,N′-tetramethyldiaminomethane, N,N,N′,N′-tetramethylethylenediamine, N,N,N′,N′-tetraethylethylenediamine, N,N,N′,N′-tetramethyldiaminopropane, N,N,N′,N′-tetraethyldiaminopropane, N,N,N′,N′-tetramethyldiaminobutane, N,N,N′,N′-tetramethyldiaminpentane, and N,N,N′,N′-tetramethyldiaminohexane. Here, in the exemplification in the present description, for example, diaminobutane shall include all isomers including isomers relating to the position of the amino group such as 1,2-diaminobutane, 1,3-diaminobutane, and 1,4-diaminobutane, and in addition thereto, linear and branched isomers regarding butane unless otherwise noted.

The number of carbon atoms in the aliphatic amine is preferably 2 or more, more preferably 4 or more, and still more preferably 6 or more, and the upper limit thereof is preferably 10 or less, more preferably 8 or less, and still more preferably 7 or less. In addition, the number of carbon atoms in the aliphatic hydrocarbon group in the aliphatic amine is preferably 2 or more, and an upper limit thereof is preferably 6 or less, more preferably 4 or less, and still more preferably 3 or less.

Representative preferred examples of the alicyclic amine include alicyclic diamines, for example, alicyclic primary diamines such as cyclopropanediamine and cyclohexanediamine; alicyclic secondary diamines such as bisaminomethylcyclohexane; and alicyclic tertiary diamines such as N,N,N′,N′-tetramethyl-cyclohexanediamine and bis(ethylmethylamino)cyclohexane. Further, representative preferred examples of the heterocyclic amine include heterocyclic diamines, for example, heterocyclic primary diamines such as isophoronediamine; heterocyclic secondary diamines such as piperazine and dipiperidylpropane; and heterocyclic tertiary diamines such as N,N-dimethylpiperazine and bismethylpiperidylpropane.

The number of carbon atoms in the alicyclic amine and the heterocyclic amine is preferably 3 or more, and more preferably 4 or more, and the upper limit is preferably 16 or less, and more preferably 14 or less.

Representative preferred examples of the aromatic amine include aromatic diamines, for example, aromatic primary diamines such as phenyldiamine, tolylenediamine and naphthalenediamine; aromatic secondary diamines such as N-methylphenylenediamine, N,N′-dimethylphenylenediamine, N,N′-bismethylphenylphenylenediamine, N,N′-dimethylnaphthalenediamine, and N-naphthylethylenediamine; and aromatic tertiary diamines such as N,N-dimethylphenylenediamine, N,N,N′,N′-tetramethylphenylenediamine, N,N,N′,N′-tetramethyldiaminodiphenylmethane, and N,N,N′,N′-tetramethylnaphthalene diamine.

The number of carbon atoms in the aromatic amine is preferably 6 or more, more preferably 7 or more, and still more preferably 8 or more, and the upper limit is preferably 16 or less, more preferably 14 or less, and still more preferably 12 or less.

The amine compound used in the present embodiment may be substituted with a substituent such as an alkyl group, an alkenyl group, an alkoxyl group, a hydroxy group, or a cyano group, or a halogen atom.

While diamines are exemplified as specific examples, the amine compound used in the present embodiment is, needless to say, not limited to diamines. For example, it is also possible to use trimethylamine, triethylamine, ethyldimethylamine, an aliphatic monoamine corresponding to any of various diamines such as the above-mentioned aliphatic diamines, as well as a piperidine compound such as piperidine, methylpiperidine, or tetramethylpiperidine, a pyridine compound such as pyridine or picoline, a morpholine compound such as morpholine, methylmorpholine, or thiomorpholine, an imidazole compound such as imidazole or methylimidazole, a monoamine, for example, an alicyclic monoamine such as a monoamine corresponding to any of the above-mentioned alicyclic diamines, a heterocyclic monoamine corresponding to any of the above-mentioned heterocyclic diamines, or an aromatic monoamine corresponding to any of the above-mentioned aromatic diamines, or in addition thereto, for example, a polyamine having 3 or more amino groups such as diethylenetriamine, N,N′,N″-trimethyldiethylenetriamine, N,N,N′,N″,N″-pentamethyldiethylenetriamine, triethylenetetramine, N,N′-bis[(dimethylamino)ethyl]-N,N′-dimethylethylenediamine, hexamethylenetetramine, or tetraethylenepentamine.

Among the above, from the viewpoint of obtaining a higher ionic conductivity, a tertiary amine having a tertiary amino group as an amino group is preferable, a tertiary diamine having two tertiary amino groups is more preferable, a tertiary diamine having two tertiary amino groups at both ends is still more preferable, and an aliphatic tertiary diamine having tertiary amino groups at both ends is even more preferable. In the above-mentioned amine compounds, as the aliphatic tertiary diamine having tertiary amino groups at both ends, tetramethylethylenediamine, tetraethylethylenediamine, tetramethyldiaminopropane, and tetraethyldiaminopropane are preferable, and in consideration of easy availability or the like, tetramethylethylenediamine and tetramethyldiaminopropane are preferable.

A compound containing a nitrogen atom as a heteroatom and having a group other than an amino group, for example, a group such as a nitro group or an amide group can also provide an effect similar to that of an amine compound.

From the viewpoint of efficiently forming a complex, the addition amount of the complexing agent 1 is such that the molar ratio of the addition amount of the complexing agent 1 to the total molar amount of Li atom contained in the solid electrolyte raw material is preferably 0.1 or more and 2.0 or less, more preferably 0.5 or more and 1.5 or less, still more preferably 0.8 or more and 1.2 or less, and most preferably 1.0.

(Complexing Agent 2 that Satisfies (2))

The complexing agent 2 used in the production method of the present embodiment is a complexing agent that satisfies the above-mentioned (2), that is, a complexing agent that is other than the complexing agent 1 and is capable of forming a complex containing Li₃PS₄ obtained from Li₂S and P₂S₅, which are preferably used as solid electrolyte raw materials, and the like.

In particular, it is preferable that the rate of forming Li₃PS₄ is faster than that of the complexing agent 1. This is because by further mixing the complexing agent 2 after mixing the complexing agent 1, it becomes possible to allow the Li₃PS₄ formation reaction, which stagnates if only the complexing agent 1 is mixed, to proceed without stagnation.

The reason why this is possible is not clear, but the following hypothesis can be considered.

The complexing agent 1 shows an excellent balance between the ability to form Li₃PS₄ and the ability to form a complex containing Li₃PS₄ and a halogen atom, but is inferior to the complexing agent 2 in its ability to form Li₃PS₄. Therefore, as the Li₃PS₄ formation reaction proceeds and the concentration of Li₂S or the like present in the system decreases, the rate of the Li₃PS₄ formation reaction slows down and gradually stagnates. However, by further mixing the complexing agent 2, which is superior to the complexing agent 1 in its ability to form Li₃PS₄, after mixing the complexing agent 1, even if the concentration of Li₂S or the like present in the reaction field is low, it becomes possible to accelerate the Li₃PS₄ formation reaction again. At this time, due to the presence of the complexing agent 1, which is superior to the complexing agent 2 in its ability to form a complex containing Li₃PS₄ and a halogen atom, the properties of both of the complexing agent 1 and the complexing agent 2 can be effectively utilized, so that the Li₃PS₄ formation reaction proceeds, and the complex containing the formed Li₃PS₄ and a halogen atom is formed without stagnation.

With respect to the above-mentioned property (2) of the complexing agent 2 that it is capable of forming a complex containing Li₃PS₄, it is known that, for example, dimethoxyethane (DME), which will be described later as the complexing agent 2, forms a complex containing Li₃PS₄ (see, for example, Chem. Mater. 2017, 29, 1830-1835, and FIG. S4 in its Supporting Information), and it is also known that, for example, tetrahydrofuran (THF) forms a complex containing Li₃PS₄ (see, for example, J. Am. Chem. Soc. 2013, 135, 975-978, especially “Decomposition of Li₃PS₄ 3THF forms β-Li₃PS₄” in p. 976, and FIG. S1 in its Supporting Information).

In this manner, the above-mentioned (2) that the complexing agent 2 satisfies, that is, the property capable of forming a complex containing Li₃PS₄ is a property that can be specifically checked.

As the complexing agent 2, any material can be used without any particular limitations as long as it has the above-mentioned performance, and a compound containing an atom having particularly high affinity for a lithium atom, for example, a heteroatom such as a nitrogen atom, an oxygen atom, or a chlorine atom is preferable, and a compound having a group containing such a heteroatom is more preferable. This is because these heteroatoms and a group containing such a heteroatom can coordinate with (bind to) a lithium atom.

The heteroatom present in the molecule of the complexing agent 2 has high affinity for a lithium atom, and is considered to have an ability to easily form a complex by binding to Li₃PS₄ containing a PS₄ structure to serve as the main skeleton of the thio-LISICON Region II-type crystal structure to serve as the basic structure of the crystalline sulfide solid electrolyte to be produced according to the present embodiment. Therefore, it is considered that by mixing the above-mentioned raw materials and the complexing agent 2, it becomes possible to accelerate the formation of a complex containing Li₃PS₄.

Further, among the heteroatoms, an oxygen atom is preferable, and a group containing an oxygen atom preferably has one or more types of functional groups selected from an ether group and an ester group, and particularly preferably has an ether group among these. That is, as the complexing agent 2, an ether compound is particularly preferable. Further, in relation to the complexing agent 1, the complexing agent 2 preferably does not contain a nitrogen atom as a heteroatom. Therefore, in the present embodiment, it is preferable that as the complexing agent 1, one containing a nitrogen atom as a heteroatom is adopted, and as the complexing agent 2, one that does not contain a nitrogen atom but contains an oxygen atom as a heteroatom is adopted. Thereby, the functions of the complexing agent 1 and the complexing agent 2 described above can be effectively utilized, so that the ionic conductivity of the crystalline sulfide solid electrolyte to be obtained can be improved.

Examples of such an ether compound include ether compounds such as an aliphatic ether, an alicyclic ether, a heterocyclic ether, and an aromatic ether, and these can be used alone or multiple types thereof can be used in combination.

More specifically, examples of the aliphatic ether include monoethers such as dimethyl ether, diethyl ether, diisopropyl ether, dibutyl ether, and tert-butyl methyl ether; diethers such as dimethoxymethane, dimethoxyethane, diethoxymethane, and diethoxyethane; polyethers having three or more ether groups such as diethylene glycol dimethyl ether (diglyme) and triethylene oxide glycol dimethyl ether (triglyme); also ethers containing a hydroxy group such as diethylene glycol and triethylene glycol.

The number of carbon atoms in the aliphatic ether is preferably 2 or more, more preferably 3 or more, and still more preferably 4 or more, and the upper limit is preferably 10 or less, more preferably 8 or less, and still more preferably 6 or less.

The number of carbon atoms in the aliphatic hydrocarbon group in the aliphatic ether is preferably 1 or more, and the upper limit is preferably 6 or less, more preferably 4 or less, and still more preferably 3 or less.

Examples of the alicyclic ether include ethylene oxide, propylene oxide, tetrahydrofuran, tetrahydropyran, dimethoxytetrahydrofuran, cyclopentyl methyl ether, dioxane, and dioxolane, and examples of the heterocyclic ether include furan, benzofuran, benzopyran, dioxene, dioxine, morpholine, methoxyindole, hydroxymethyl dimethoxypyridine.

The number of carbon atoms in the alicyclic ether and the heterocyclic ether is preferably 3 or more, and more preferably 4 or more, and the upper limit is preferably 16 or less, and more preferably 14 or less.

Examples of the aromatic ether include methyl phenyl ether (anisole), ethyl phenyl ether, dibenzyl ether, diphenyl ether, benzylphenyl ether, and naphthyl ether.

The number of carbon atoms in the aromatic ether is preferably 7 or more, and more preferably 8 or more, and the upper limit is preferably 16 or less, more preferably 14 or less, and still more preferably 12 or less.

The ether compound used in the present embodiment may be substituted with a substituent such as an alkyl group, an alkenyl group, an alkoxyl group, a hydroxy group, or a cyano group, or a halogen atom.

From the viewpoint of obtaining a higher ionic conductivity, the ether compound used in the present embodiment is preferably an aliphatic ether, and more preferably dimethoxyethane or tetrahydrofuran.

Examples of the ester compound include ester compounds such as an aliphatic ester, an alicyclic ester, a heterocyclic ester, and an aromatic ester, and these can be used alone or multiple types thereof can be used in combination.

More specific examples of the aliphatic ester include formate esters such as methyl formate, ethyl formate, and triethyl formate; acetate esters such as methyl acetate, ethyl acetate, propyl acetate, isopropyl acetate, butyl acetate, and isobutyl acetate; propionate esters such as methyl propionate, ethyl propionate, propyl propionate, and butyl propionate; oxalate esters such as dimethyl oxalate and diethyl oxalate; malonate esters such as dimethyl malonate and diethyl malonate; and succinate esters such as dimethyl succinate and diethyl succinate.

The number of carbon atoms in the aliphatic ester is preferably 2 or more, more preferably 3 or more, and still more preferably 4 or more, and the upper limit is preferably 10 or less, more preferably 8 or less, and still more preferably 7 or less. Further, the number of carbon atoms in the aliphatic hydrocarbon group in the aliphatic ester is preferably 1 or more, and more preferably 2 or more, and the upper limit is preferably 6 or less, more preferably 4 or less, and still more preferably 3 or less.

Examples of the alicyclic ester include methyl cyclohexanecarboxylate, ethyl cyclohexanecarboxylate, dimethyl cyclohexanedicarboxylate, dibutyl cyclohexanedicarboxylate, and dibutyl cyclohexanedicarboxylate, and examples of the heterocyclic ester include methyl pyridinecarboxylate, ethyl pyridinecarboxylate, propyl pyridinecarboxylate, methyl pyrimidinecarboxylate, ethyl pyrimidinecarboxylate, and lactones such as acetolactone, propiolactone, butyrolactone, and valerolactone.

The number of carbon atoms in the alicyclic ester and the heterocyclic ester is preferably 3 or more, and more preferably 4 or more, and the upper limit is preferably 16 or less, and more preferably 14 or less.

Examples of the aromatic ester include benzoate esters such as methyl benzoate, ethyl benzoate, propyl benzoate, and butyl benzoate; phthalate esters such as dimethyl phthalate, diethyl phthalate, dibutyl phthalate, butyl benzyl phthalate, and dicyclohexyl phthalate; trimellitate esters such as trimethyl trimellitate, triethyl trimellitate, tripropyl trimellitate, tributyl trimellitate, and trioctyl trimellitate.

The number of carbon atoms in the aromatic ester is preferably 8 or more, and more preferably 9 or more, and the upper limit is preferably 16 or less, more preferably 14 or less, and still more preferably 12 or less.

The ester compound used in the present embodiment may be substituted with a substituent such as an alkyl group, an alkenyl group, an alkoxyl group, a hydroxy group, or a cyano group, or a halogen atom.

From the viewpoint of obtaining a higher ionic conductivity, the ester compound used in the present embodiment is preferably an aliphatic ester, more preferably an acetate ester, and particularly preferably ethyl acetate.

Further, in the present embodiment, it is preferable to mix the complexing agent 2 after the complex formation reaction by the complexing agent 1 has proceeded to a certain extent.

The method for measuring the appropriate timing to add the complexing agent 2 is not particularly limited, and for example, when lithium sulfide is used as one of the solid electrolyte raw materials, by adding the complexing agent 2 at the timing when the residual amount of lithium sulfide present in the system has decreased to a certain level, a higher effect can be exhibited.

Specifically, the complex formation reaction can be further accelerated by adding the complexing agent 2 after the residual amount of lithium sulfide decreases to preferably 35 mol % or less, more preferably 30 mol % or less, and still more preferably 25 mol % or less with respect to the input amount. The amount of lithium sulfide remaining in the system can be measured by the method described in Examples.

From the viewpoint of efficiently forming a complex, the addition amount of the complexing agent 2 is such that the number of moles of the amount of the complexing agent 2 used with respect to the total number of moles of Li₃PS₄ produced from the raw material-containing material is preferably 0.1 or more and 5.0 or less, more preferably 0.2 or more and 4.0 or less, and still more preferably 0.5 or more and 3.5 or less.

Further, from a similar viewpoint, the number of moles of the amount of the complexing agent 2 used with respect to the total molar amount of Li atom contained in the solid raw material is preferably 0.01 or more and 5.0 or less, more preferably 0.05 or more and 3.0 or less, and still more preferably 0.1 or more and 2.0 or less.

### (Solvent)

In the present embodiment, a solvent can be further added when the solid electrolyte raw materials and the complexing agents are mixed.

When a complex in a solid state is formed in a complexing agent in a liquid state, separation of a component may occur if the complex is easily soluble in the complexing agent. Therefore, use of a solvent in which the complex does not dissolve can prevent elution of a component in the electrolyte precursor. In addition, mixing of the raw materials and the complexing agents using a solvent promotes complex formation, and can make each main component present more evenly, so that an electrolyte precursor in which a halogen atom is more highly dispersed and fixed is obtained. As a result, the effect of obtaining a high ionic conductivity is more easily exhibited.

The method for producing a crystalline sulfide solid electrolyte of the present embodiment is a so-called heterogeneous method, and it is preferable that the complex precipitates without completely dissolving in the complexing agent in a liquid state. The solubility of the complex can be adjusted by adding a solvent. In particular, a halogen atom is easily eluted from the complex, and therefore, by adding a solvent, the elution of a halogen atom is prevented, so that a desired complex is obtained. As a result, a crystalline sulfide solid electrolyte having a high ionic conductivity can be obtained through an electrolyte precursor in which a component such as a halogen atom is dispersed.

Preferred examples of the solvent having such properties include a solvent having a solubility parameter of 10 or less. In the present description, the solubility parameter is described in various documents, for example, “Handbook of Chemistry” (published in 2004, Revised 5th Edition, Maruzen Publishing Co., Ltd.) and is a value δ ((cal/cm³)^{1/2}) calculated according to the following numerical formula (1), and is also referred to as a Hildebrand parameter, SP value.

$$δ = \sqrt{( Δ H - RT ) / V} \qquad ( 1 )$$

In the numerical formula (1), AH is a molar heating value, R is a gas constant, T is a temperature, and V is a molar volume.

Use of the solvent having a solubility parameter of 10 or less makes a halogen atom, a raw material containing a halogen atom such as a lithium halide, and further a component containing a halogen atom forming a co-crystal contained in a complex (for example, an aggregate in which a lithium halide and the complexing agent are bound to each other), and the like relatively hardly soluble as compared with the complexing agent, so that it becomes easier to fix a halogen atom in the complex. Therefore, in the electrolyte precursor to be obtained and further in the crystalline sulfide solid electrolyte, a halogen atom is present in a well-dispersed state, and so that it becomes easy to obtain a crystalline sulfide solid electrolyte having a high ionic conductivity. That is, it is preferable that the solvent used in the present embodiment has such properties that it does not dissolve the complex. From a similar viewpoint, the solubility parameter of the solvent is preferably 9.5 or less, more preferably 9.0 or less, and still more preferably 8.5 or less.

More specifically, as the solvent used in the present embodiment, it is possible to broadly adopt a solvent which has hitherto generally been used in the production of a solid electrolyte. Examples thereof include hydrocarbon solvents such as an aliphatic hydrocarbon solvent, an alicyclic hydrocarbon solvent, and an aromatic hydrocarbon solvent; and carbon atom-containing solvents such as an alcohol-based solvent, an ester-based solvent, an aldehyde-based solvent, a ketone-based solvent, an ether-based solvent having 4 or more carbon atoms on one side, and a solvent containing a carbon atom and a heteroatom, and the solvent may be used by being appropriately selected from these, preferably from solvents having a solubility parameter falling within the above range.

More specific examples of the solvent include aliphatic hydrocarbon solvents such as hexane (7.3), pentane (7.0), 2-ethylhexane, heptane (7.4), octane (7.5), decane, undecane, dodecane, and tridecane; alicyclic hydrocarbon solvents such as cyclohexane (8.2) and methylcyclohexane; aromatic hydrocarbon solvents such as benzene, toluene (8.8), xylene (8.8), mesitylene, ethylbenzene (8.8), tert-butylbenzene, trifluoromethylbenzene, nitrobenzene, chlorobenzene (9.5), chlorotoluene (8.8), and bromobenzene; alcohol-based solvents such as ethanol (12.7) and butanol (11.4); aldehyde-based solvents such as formaldehyde, acetaldehyde (10.3), and dimethylformamide (12.1); ketone-based solvents such as acetone (9.9) and methyl ethyl ketone; ether-based solvents such as dibutyl ether, cyclopentylmethyl ether (8.4), tert-butylmethyl ether, and anisole; and solvents containing a carbon atom and a heteroatom such as acetonitrile (11.9), dimethyl sulfoxide, and carbon disulfide. The numerical values in the parentheses in the above examples are SP values.

Among these solvents, an aliphatic hydrocarbon solvent, an alicyclic hydrocarbon solvent, an aromatic hydrocarbon solvent, and an ether-based solvent are preferable, and from the viewpoint of more stably obtaining a higher ionic conductivity, heptane, cyclohexane, toluene, ethylbenzene, diethyl ether, diisopropyl ether, dibutyl ether, dimethoxyethane, cyclopentylmethyl ether, tert-butylmethyl ether, and anisole are more preferable, diethyl ether, diisopropyl ether, and dibutyl ether are still more preferable, diisopropyl ether and dibutyl ether are even more preferable, and cyclohexane is particularly preferable. The solvent used in the present embodiment is preferably an organic solvent as exemplified above and is an organic solvent different from the complexing agent. In the present embodiment, these solvents may be used alone or multiple types may be used in combination.

### (Mixing)

In the present embodiment, first mixing of mixing the raw material-containing material and the complexing agent 1 are mixed, and second mixing of subsequently mixing with the complexing agent 2 are included. In the present embodiment, the form of mixing of the raw material-containing material and the complexing agents may be either a solid form or a liquid form, but the solid electrolyte raw materials contained in the raw material-containing material usually include a solid, and the complexing agents are in a liquid form, and therefore mixing is usually performed in a form where a solid raw material is present in the complexing agents in a liquid state. Further, when the solid electrolyte raw materials and the complexing agents are mixed, a solvent may be further mixed as necessary.

Hereinafter, in the description of the mixing of the solid electrolyte raw materials and the complexing agents, the complexing agents shall also contain a solvent to be added as necessary unless otherwise specified.

There are no particular limitations on the mixing method of the raw material-containing material, the complexing agent 1, and the complexing agent 2 in the first mixing and the second mixing, and it is only necessary to perform mixing by introducing the solid electrolyte raw materials and the complexing agents into an apparatus capable of mixing the solid electrolyte raw materials contained in the raw material-containing material and the complexing agents. For example, if the solid electrolyte raw materials are gradually added after the complexing agent is supplied into a tank and a stirring blade is activated, a good mixing state of the solid electrolyte raw materials is obtained, and the dispersibility of the solid electrolyte raw materials is improved, and therefore, this method is preferable.

However, when a halogen simple substance is used as a solid electrolyte raw material, the solid electrolyte raw material may not be solid, and specifically, at normal temperature and normal pressure, fluorine and chlorine are gaseous, and bromine is liquid. In such a case, for example, when a solid electrolyte raw material is liquid, it is only necessary to supply it into a tank together with the complexing agent separately from other solid electrolyte raw materials in a solid state, and when a solid electrolyte raw material is gaseous, it is only necessary to supply it by blowing into a material obtained by adding the solid raw materials to the complexing agent.

The production method of the present embodiment is configured to include mixing the raw material-containing material and the complexing agents, and the production can also be performed by a method without using an apparatus, which is generally called a pulverizer, and is used for the purpose of pulverizing a solid electrolyte raw material in a solid state, for example, a medium-type pulverizer such as a ball mill or a bead mill. That is, by simply mixing the raw material-containing material and the complexing agents through the first mixing and the second mixing, the solid electrolyte raw materials contained in the raw material-containing material and the complexing agents are mixed, and Li₃PS₄, and further complexes such as a complex containing a halogen atom and a complex containing Li₃PS₄ can be formed. In order to shorten the mixing time for obtaining a complex or to form a fine powder, the mixture of the raw material-containing material and the complexing agents may be pulverized with a pulverizer. However, from the viewpoint of improving the productivity, it is preferable that a pulverizer is not used in at least the first mixing, that is, it is preferable that pulverization mixing is not performed in the first mixing.

As an apparatus for mixing the raw material-containing material and the complexing agents, any general mixer can be used without any particular limitations, and examples thereof include a mechanical stirring-type mixer equipped with a stirring blade in a tank. Examples of the mechanical stirring-type mixer include a high-speed stirring-type mixer and a double-arm-type mixer, and from the viewpoint of enhancing the uniformity of the raw materials in the mixture of the raw material-containing material and the complexing agents and obtaining a higher ionic conductivity, a high-speed stirring-type mixer is preferably used. Further, examples of the high-speed stirring-type mixer include a vertical axis rotating-type mixer and a horizontal axis rotating-type mixer, and a mixer of either type may be used.

Examples of a shape of the stirring blade used in the mechanical stirring-type mixer include an anchor type, a blade type, an arm type, a ribbon type, a multistage blade type, a double arm type, a shovel type, a twin-shaft blade type, a flat blade type, and a C-type blade type, and from the viewpoint of enhancing the uniformity of the raw materials in the raw material and obtaining a higher ionic conductivity, a shovel type, a flat blade type and a C-type blade type are preferable. Further, in a mechanical stirring-type mixer, it is preferable to install a circulation line for discharging the object to be stirred to the outside of the mixer and then returning it to the inside of the mixer. This allows a raw material with a heavy specific gravity such as a lithium halide to be stirred without precipitation or stagnation, so that more uniform mixing can be achieved.

The installation location of the circulation line is not particularly limited, and it is preferably installed at a location where the raw materials are discharged from the bottom of the mixer and returned to the top of the mixer. This makes it easier to uniformly stir a raw material that is likely to precipitate through the convection due to circulation. Further, it is preferable that the return port is located below the surface of the liquid to be stirred. This can prevent the liquid to be stirred from splashing and adhering to the wall surface inside the mixer.

The temperature condition when the raw material-containing material and the complexing agents are mixed is not particularly limited, and is, for example −30 to 100° C., preferably −10 to 50° C., more preferably about room temperature (23° C.) (for example, room temperature±5° C.). The mixing time can vary depending on the type of stirrer to be used or the like, and therefore cannot be generalized, but is usually about 0.1 to 150 hours, and from the viewpoint of achieving more uniform mixing and obtaining a higher ionic conductivity, it is preferably 1 to 120 hours, more preferably 4 to 100 hours, and still more preferably 8 to 80 hours.

### (Complex)

By mixing the raw material-containing material and the complexing agents, due to the action between a lithium atom, a phosphorus atom, a sulfur atom, and a halogen atom contained in the raw material-containing material and the complexing agents, for example, a complex containing a halogen atom, and also a complex in which these atoms are bonded via the complexing agent and/or directly bonded without via the complexing agent such as a complex containing Li₃PS₄ are obtained. That is, in the production method of the present embodiment, the complex obtained by mixing the raw material-containing material and the complexing agent includes those formed of the complexing agent, a lithium atom, a phosphorus atom, a sulfur atom, and a halogen atom. The complex obtained in the present embodiment is not completely dissolved in the complexing agent in a liquid state, and is usually in a solid state, and therefore a fluid obtained through the first mixing and the second mixing becomes a complex and a suspension in which a complex is suspended in a solvent to be added as necessary. Therefore, it can be said that the production method of the present embodiment corresponds to a heterogeneous system in a so-called liquid phase method.

A co-crystal is formed of a complexing agent, a lithium atom, a phosphorus atom, a sulfur atom, and a halogen atom, and it is assumed that the co-crystal typically forms a complex structure in which a lithium atom and another atom are bonded via the complexing agent and/or directly bonded without via the complexing agent.

Here, the fact that the complexing agent forms a co-crystal can be checked, for example, by gas chromatography analysis. Specifically, the complexing agent contained in the co-crystal can be quantified by dissolving the powder of the complex in methanol and performing gas chromatography analysis of the resulting methanol solution.

The content of the complexing agent in the complex varies depending on the molecular weight of the complexing agent, but is usually about 10% by mass or more and 70% by mass or less, and preferably 15% by mass or more and 65% by mass or less.

In the production method of the present embodiment, it is preferable to form a co-crystal containing a halogen atom from the viewpoint of improving the ionic conductivity. Use of the complexing agent 1 makes it easy to obtain a co-crystal in which a halogen atom is more highly dispersed and fixed by bonding (coordinating) Li₃PS₄ and a solid electrolyte raw material containing a lithium atom and a halogen atom such as a lithium halide via the complexing agent 1, and the ionic conductivity is improved.

The fact that the halogen atom in the complex forms a co-crystal can be checked based on the fact that a predetermined amount of the halogen atom is contained in the complex even after solid-liquid separation of the fluid obtained through the second mixing is performed. This is because the halogen atom that does not form the co-crystal is eluted more easily than the halogen atom that forms the co-crystal and is discharged into the liquid in solid-liquid separation. Further, it can also be checked based on the fact that the proportion of the halogen atom in the complex or the solid electrolyte does not significantly decrease as compared with the proportion of the halogen atom supplied from the raw materials by composition analysis using ICP analysis (inductively coupled plasma emission spectrometry) of the complex or the solid electrolyte.

The amount of the halogen atom remaining in the complex is preferably 30% by mass or more, more preferably 35% by mass or more, and still more preferably 40% by mass or more with respect to the composition for preparation. The upper limit of the amount of the halogen atom remaining in the complex is 100% by mass.

### (Residual Amount of Li₂S)

In the present embodiment, the residual amount of Li₂S at the time when the first mixing is completed is preferably 1.0% or more, more preferably 3.0% or more, and still more preferably 5.0% or more, and the upper limit is preferably 35.0% or less, more preferably 30.0% or less, and still more preferably 25.0% or less. When the the residual amount of Li₂S is set within the above range, it becomes easier to more efficiently obtain a crystalline sulfide solid electrolyte having a higher ionic conductivity.

In the present description, the “residual amount of Li₂S” refers to the amount of unreacted Li₂S in the reaction field when Li₂S is used as a raw material determined by the method described in Examples, and is a numerical value that serves as an index to understand the progress of the reaction.

The residual amount of Li₂S at the time when the second mixing is completed is preferably as small as possible, and is specifically, preferably 20.0% or less, more preferably 15.0% or less, still more preferably 10.0%, even more preferably 5.0% or less, and particularly preferably 2.5% or less.

According to the production method of the present embodiment, the sequential use of two different types of complexing agents 1 and 2 can reduce the residual amount of Li₂S to an extremely small amount as described above, and therefore, it becomes possible to efficiently obtain a crystalline sulfide solid electrolyte having a high ionic conductivity.

### (Instant Drying Step)

The method for producing a crystalline sulfide solid electrolyte of the present embodiment includes an instant drying step of drying by contact with a medium after the second mixing. In this step, the complexing agents are removed from the fluid containing Li₃PS₄, and further complexes such as a complex containing a halogen atom and a complex containing Li₃PS₄, and the complexing agents obtained through the second mixing, and a powder of an electrolyte precursor and further a powder of a sulfide solid electrolyte are obtained.

In addition, the complexing agents can be instantaneously removed from the fluid by bringing the fluid into contact with a medium to dry the fluid, and therefore, it is possible to prevent the elution of a component that is easily eluted in the complexing agents from Li₃PS₄, and further complexes such as a complex containing a halogen atom and a complex containing Li₃PS₄, and as a result, a crystalline sulfide solid electrolyte having a high ionic conductivity is obtained.

In the present description, the “instant drying step” means a step that enables instant drying, and although it can vary depending on the method to be adopted, and therefore cannot be generalized, the “instant” means 1 minute or less as the time required for the fluid (usually a slurry) obtained through the first mixing and the second mixing to turn into a powder of an electrolyte precursor or the like (that is, the time for which the fluid is heated), and is preferably 45 seconds or less, more preferably 30 seconds or less, and still more preferably 15 seconds or less.

There are no particular limitations on the method of instant drying of drying by contact with a medium as long as the fluid can be dried by contact with a medium, that is, the complexing agents can be removed from the fluid, and preferred examples thereof include fluidized drying using media particles as the medium, drying with a spray dryer, and airflow drying. In the production method of the present embodiment, it is preferable to perform drying by at least one method selected from fluidized drying using media particles as the medium, drying with a spray dryer, and airflow drying. Here, the spray dryer uses a gas as the medium as described later, and therefore is a method of drying by contact with a medium. The same applies to airflow drying.

In fluidized drying using a medium, the fluid (slurry), which is obtained through the second mixing and is an object to be dried, is fluidized so as to increase the heat transfer area of the fluid and promote rapid and uniform heat transfer, and thus, instant drying can be achieved. Thereby, the elution of a component, such as a halogen atom, that is easily eluted in the complexing agents can be prevented as much as possible, and deterioration of quality such as a decrease in ionic conductivity can be prevented.

Further, since the fluid is fluidized using a medium, the fluid can be dried uniformly almost without being affected by the viscosity of the fluid, so that fluidized drying can be applied to a fluid with a viscosity in a wide range.

### (Fluidized Drying)

In the fluidized drying using media particles as the medium, when fluidized drying is performed while fluidizing the media particles in a dryer, the medium is already heated in the dryer so that the medium is in a state having an amount of heat. The fluid to become an object to be dried increases the heat transfer area by being fluidized with a fluidized catalytic cracking catalyst of the media particles, and is also heated by the amount of heat of the medium, and therefore it becomes possible to further shorten the time for removing the complexing agents and drying.

By performing such drying, it is also possible to prevent aggregation caused by a dry state with low uniformity due to conventionally adopted drying, for example, batch drying such as vacuum drying and to prevent deterioration of the quality while preventing the decrease in ionic conductivity due to the elution of a component, such as a halogen atom, that is easily eluted in the complexing agents, which is the advantage of the instant drying described above. Further, as the fluidized drying using a medium, a flow type can be adopted, and therefore excellent productivity can also be obtained.

As the dryer capable of fluidized drying using a medium (also referred to as “medium fluidized dryer”), any dryer can be used without any particular limitations as long as the dryer can dry while fluidizing the fluid to become an object to be dried due to the media particles to serve as a medium, and it is also possible to use a dryer commercially available as a fluidized bed drying apparatus, in which media particles are contained as a medium in the dryer, and is of a type that performs drying while fluidizing the media particles.

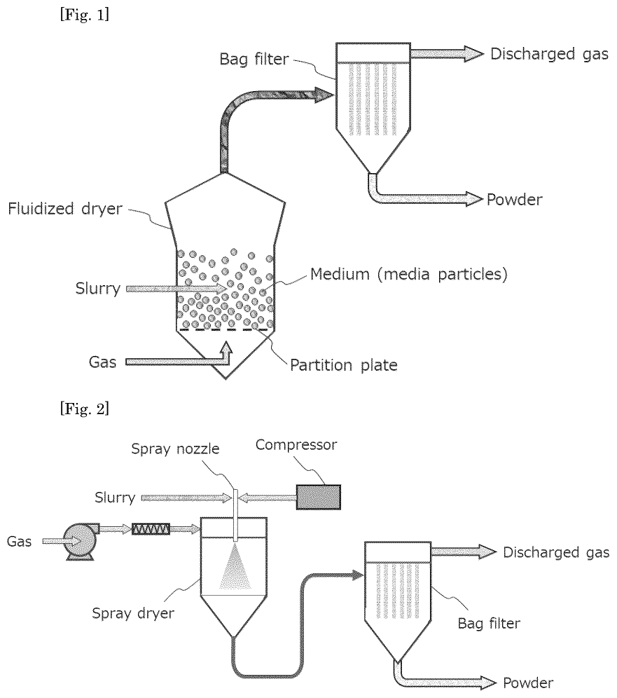

A preferred embodiment of a drying apparatus that can perform fluidized drying using a medium that can be used in the present embodiment will be described with reference to FIG. 1. The drying apparatus shown in FIG. 1 includes a medium fluidized dryer that can perform fluidized drying using media particles as a medium by fluidizing the medium, as well as a bag filter for recovering a solid (powder) contained in the fluid, and a powder of an electrolyte precursor or the like obtained by removing the complexing agents from complexes such as a complex containing a halogen atom and a complex containing Li₃PS₄ discharged by the dryer.

The medium fluidized dryer shown in FIG. 1 is of a type that uses media particles as a medium, and is an apparatus in which the media particles in the dryer are fluidized with a gas, a fluid is supplied into a fluidized bed of the media particles and the complexing agents are removed from the fluid to dry the fluid. When the fluid is supplied into the fluidized bed of the media particles, the fluid is fluidized and the heat transfer area increases, so that drying in a shorter time can be achieved.

In the dryer, a partition plate preferably with multiple vents for supplying a gas is provided. By providing the partition plate, the media particles to serve a medium convect in the dryer with the gas supplied into the dryer through the vents without staying on the bottom to form a fluidized bed.

The medium fluidized dryer, at its top, has a discharge port for discharging a fluid containing the gas supplied from the bottom of the dryer, and a powder contained in the fluid obtained by the second mixing, that is, a powder of an electrolyte precursor or the like, and the fluid discharged from the discharge port is supplied to the bag filter. The bag filter includes a multi-stage filter, and the powder in the fluid is collected by the filter and recovered as an electrolyte precursor or the like, and the gas in the fluid is discharged from the discharge port at the top of the bag filter.

In the medium fluidized dryer, media particles are used as the medium, and as shown in FIG. 1, a type in which the media particles are maintained in a fluidized state by a gas is effective. As the gas, it is preferable to use an inert gas such as nitrogen or argon from the viewpoint of preventing deterioration of the electrolyte precursor or the like due to oxidation, and it is more preferable to use nitrogen in consideration of cost.

As the media particles, it is preferable to use ceramic balls in consideration of drying efficiency, fluidity, and the like. The particle diameter of the media particles varies depending on the size of the fluidized dryer, or the like, and therefore cannot be defined unconditionally, but it is only necessary to use those having a particle diameter of generally about 0.5 mm or more and 5.0 mm or less, and preferably 1.0 mm or more and 3.0 mm or less in consideration of drying efficiency, fluidizability, and the like. When the particle diameter of the media particles is within the above range, it is possible to prevent exhaust to the outside of the dryer together with the fluid containing the gas used in the fluidized drying and the electrolyte precursor or the like contained in the dried fluid, and thus the collection amount in the bag filter can be reduced.

When a gas is used to fluidize the medium, the gas is preferably a heated gas. In the case of a medium fluidized dryer of the type shown in FIG. 1, a gas also serves as a heat source for drying the fluid, and therefore a heated gas is used.

The media particles are also preferably heated ones. In the case of a medium fluidized dryer of the type shown in FIG. 1, the media particles are in a state of being heated by the heated gas, so that the fluid to become an object to be dried is heated by the gas and is heated by the media particles heated by the gas, and thus can be dried in an extremely short time.

As for the drying temperature in this drying, the drying can be performed at a temperature according to the complexing agents contained in the fluid and the type of solvent other than the complexing agents to be used as necessary. For example, the drying can be performed at a temperature equal to or higher than the boiling points of the complexing agents and the solvent other than the complexing agents to be used as necessary. In this manner, the drying temperature varies depending on the boiling points of the complexing agents to be used, or the like, and therefore cannot be defined unconditionally, but is generally about 50 to 150° C., preferably 55 to 130° C., more preferably 60 to 100° C., and still more preferably 65 to 80° C.

For example, in the case of using a medium fluidized dryer of the type shown in FIG. 1, the supply temperature of the gas may be generally set to about 60 to 200° C. and, from the viewpoint of drying in a shorter time, it is preferably set to 70 to 180° C., more preferably 80 to 160° C., and still more preferably 90 to 150° C. Based on the supply temperature, the supply rate of the gas may be generally set to about 0.5 to 10.0 m/s and from the viewpoint of maintaining good fluidizability of the media particles, it is preferably set to 1.0 to 8.0 m/s, more preferably 1.5 to 5.0 m/s, and still more preferably 2.0 to 3.5 m/s. The supply rate of the gas is a linear velocity with respect to the area of a cross section of the fluidized bed of the media particles to serve as a medium in a direction perpendicular to the flow direction of the gas (in other words, the area of a cross section of a container, in which the media particles are housed, in the dryer in a direction perpendicular to the flow direction of the gas).

The temperature of the fluid at the discharge port of the fluidized dryer, that is, the fluid containing the gas supplied as the heat medium and the powder of the electrolyte precursor or the like contained in the fluid to become an object to be dried is generally set to about 50 to 120° C., and from a similar viewpoint, it is preferably 55 to 100° C., more preferably 60 to 90° C., and still more preferably 65 to 80° C. When the temperature is within the above range, the drying temperature in the fluidized dryer can be easily adjusted to the above preferred range of the drying temperature. The temperature of the fluid can be adjusted by the supply rate and temperature of the gas, the supply rate of the fluid to become an object to be dried, or the like, and is easily adjusted by the supply rate of the fluid.

In the production method of the present embodiment, as shown in FIG. 1, a bag filter is preferably used from the viewpoint of efficiently collecting the powder obtained by drying, that is, the electrolyte precursor or the like.

As a filter to be used for the bag filter, any filter can be used without any particular limitations, and examples thereof include filters made of a material such as polypropylene, nylon, acrylic, polyester, cotton, wool, heat-resistant nylon, polyamide/polyimide, PPS (polyphenylene sulfide), glass fibers, or PTFE (polytetrafluoroethylene), and a functionalized filter such as an electrostatic filter can also be used. Among them, a filter made of heat-resistant nylon, polyamide/polyimide, PPS (polyphenylene sulfide), glass fibers, or PTFE (polytetrafluoroethylene) is preferable, a filter made of heat-resistant nylon, PPS (polyphenylene sulfide), or PTFE (polytetrafluoroethylene) is more preferable, and a filter made of PTFE (polytetrafluoroethylene) is particularly preferable.

Further, the bag filter may have a brushing-off unit, and for example, a pulsating back pressure-type unit and a pulse jet-type unit are preferable, and a pulse jet-type unit is particularly preferable.

A line from a discharge port of the bag filter may be provided with an induced draft fan in order to forcibly discharge the gas to be discharged from the discharge port. By discharging the gas using an induced draft fan or the like, filtration in the bag filter proceeds smoothly and a stable fluidized bed of the media particles is obtained in the fluidized dryer, so that the slurry can be dried in a shorter time.

### (Spray Dryer)

Examples of a spray dryer that can be used in the instant drying step include a dryer in the form of drying by ejecting the fluid obtained through the second mixing from a spray nozzle together with a heated gas (which may be an unheated gas), and if necessary, by bringing the fluid into contact with a separately heated gas (which may be an unheated gas). An apparatus having a preferred form as a spray dryer is shown in FIG. 2.

The spray dryer shown in FIG. 2 is configured to eject a slurry from a spray nozzle using a gas, and dry the slurry by contact with a heated gas supplied from a separate line.

The spray dryer may include multiple input lines, and there are no particular limitations on the type of input line, and the spray dryer may be of a type that can eject multiple fluids from one nozzle, and for example, a spray dryer of a type that includes a nozzle called a 4-fluid nozzle, including two nozzles that eject a slurry and two nozzles that eject a gas is preferably exemplified.

The use conditions in the case of using a spray dryer may be determined appropriately according to the type of complexing agent contained in the fluid to become an object to be dried, that is, the conditions vary depending on the boiling points of the complexing agents and the solvent to be used as necessary, or the like, and therefore cannot be defined unconditionally, but the supply temperature of a gas to the spray dryer may be preferably generally set to about 60 to 200° C., and from the viewpoint of drying in a shorter time, it is preferably 80 to 190° C., more preferably 90 to 175° C., and still more preferably 100 to 160° C.

Further, from a similar viewpoint, the supply rate of the gas may be generally set to about 0.001 to 1.0 m/s, preferably 0.005 to 0.5 m/s, more preferably 0.01 to 0.1 m/s, and still more preferably 0.015 to 0.05 m/s based on the supply temperature and the cross section of the spray dryer. As described above, the supply rate of the gas can vary greatly depending on the supply temperature and the cross section of the spray dryer, and therefore, the numerical range of the supply rate is based on a supply temperature of 100° C. and a cross-sectional diameter of the spray dryer of 1,000 mm, and may be determined according to the supply temperature and the diameter of the spray dryer.

With respect to the use conditions in the case of using a spray dryer, furthermore, the supply rate of the gas supplied to the nozzle is not particularly limited as long as the fluid can be ejected in a spray form from the nozzle, but may be generally set to about 5 to 100 NL/min, and from the viewpoint of drying in a shorter time, it is preferably 10 to 80 NL/min, more preferably 20 to 70 NL/min, still more preferably 30 to 60 NL/min, and even more preferably 35 to 45 NL/min.

Further, the supply rate of the fluid obtained through the second mixing to the nozzle can vary depending on the scale of the spray dryer, and therefore cannot be defined unconditionally, and may be determined appropriately according to the scale, and may be generally set to about 1 to 50 g/min, and from the viewpoint of drying in a shorter time, it is preferably 3 to 40 g/min, more preferably 5 to 30 g/min, and still more preferably 10 to 20 g/min.

The fluid that has passed through the spray dryer and contains a gas supplied as a heat medium or the like and a powder of an electrolyte precursor or the like contained in the fluid to become an object to be dried is supplied to a bag filter and the powder of an electrolyte precursor or the like may be recovered in the same manner as in the fluidized drying described above. As the bag filter, the bag filter described as one that can be used in the fluidized drying may be adopted.

### (Airflow Drying)

In the instant drying step, airflow drying can also be adopted. In the airflow drying, a commercially available apparatus may be used as an airflow drying apparatus, and examples thereof include an apparatus in the form of supplying a heated gas to a drying tube (which may be a cylindrical tank), and supplying the fluid to become an object to be dried is supplied to the drying tube. An airflow drying apparatus including a cylindrical tank is configured not to include a fluidized bed in the fluidized drying (fluidization with media particles is not performed), and therefore, it is also possible to perform airflow drying using a fluidized drying apparatus as shown in FIG. 1.

With respect to the use conditions in the case of adopting airflow drying, the drying temperature and the conditions of the air flow (gas) to be supplied for drying may be determined appropriately according to the type of complexing agent contained in the fluid to become an object to be dried, that is, the use conditions vary depending on the boiling points of the complexing agents and the solvent to be used as necessary, or the like, and therefore cannot be defined unconditionally, but may be determined from the conditions of the drying temperature, the supply temperature and the supply rate of the gas in the fluidized drying described above.

Further, the fluid that contains a gas supplied as a heat medium or the like and a powder of an electrolyte precursor or the like contained in the fluid to become an object to be dried after being subjected to airflow drying is supplied to a bag filter and the powder of an electrolyte precursor or the like may be recovered in the same manner as in the fluidized drying described above. As the bag filter, the bag filter described above as one that can be used in the fluidized drying described above may be adopted.

In addition to the instant drying described above, drying may be performed by filtration using a glass filter or the like, solid-liquid separation by decantation, or solid-liquid separation using a centrifuge or the like. For example, energy consumption can be reduced by partially removing the complexing agents in advance by solid-liquid separation or the like and then performing drying by the instant drying.

Specifically, solid-liquid separation is easily performed by decantation in which the fluid (slurry) obtained through the second mixing is transferred to a container, and after a solid precipitates, the complexing agents and the solvent to be added as necessary, which become a supernatant, are removed, or for example, filtration using a glass filter with a pore size of about 10 to 200 μm, preferably 20 to 150 μm.

### (Heating)

The method for producing a crystalline sulfide solid electrolyte of the present embodiment may further include heating. The powder obtained by the instant drying step contains a crystalline sulfide solid electrolyte as described above, and can also contain an electrolyte precursor, an amorphous sulfide solid electrolyte, or the like in addition thereto.

Therefore, by including heating, a material contained other than a crystallized sulfide-based solid electrolyte, such as an electrolyte precursor or an amorphous sulfide solid electrolyte is crystallized, and the purity of the crystalline sulfide solid electrolyte can be improved. Further, it is also possible to improve the crystallinity of the crystalline sulfide solid electrolyte contained in the powder obtained by the instant drying step. As a result, a crystalline sulfide solid electrolyte in which the purity of the crystalline sulfide solid electrolyte is high and the quality is excellent is obtained.

In the production method of the present embodiment, the crystalline sulfide solid electrolyte is obtained by removing the complexing agents by the instant drying step from the fluid containing Li₃PS₄, and further complexes such as a complex containing a halogen atom and a complex containing Li₃PS₄, and the complexing agents obtained through the second mixing to obtain an electrolyte precursor or the like, further followed by crystallization by heating as necessary. It is preferable that the amount of the complexing agents in the crystalline sulfide solid electrolyte is as small as possible, but the complexing agents may be contained to such an extent that they do not impair the performance. The content of the complexing agents in the crystalline sulfide solid electrolyte may generally be 10% by mass or less, and is preferably 5% by mass or less, more preferably 3% by mass or less, and still more preferably 1% by mass or less.

Conventionally, in order to obtain a crystalline sulfide solid electrolyte having a thio-LISICON Region II-type crystal structure with a high ionic conductivity, it was necessary to produce an amorphous solid electrolyte through a mechanical pulverization treatment such as mechanical milling, or a melt quenching treatment or the like, followed by heating the amorphous solid electrolyte. However, it can be said that the production method of the present embodiment is superior to the conventional production method by a mechanical milling treatment or the like in that a crystalline solid electrolyte having a thio-LISICON Region II-type crystal structure is obtained even by a method that does not involve a mechanical pulverization treatment, or a melt quenching treatment or the like.

In the method for producing a crystalline sulfide solid electrolyte of the present embodiment, the fluid obtained by the instant drying step may contain solids (powders) of an electrolyte precursor, an amorphous sulfide solid electrolyte, a crystalline sulfide solid electrolyte, and the like. The heating temperature during heating is preferably set within the following temperature range, regardless of the solid (powder) contained in the fluid.

The heating temperature may be set within the range of the temperature at which the crystalline sulfide solid electrolyte to be obtained is crystallized (for example, the peak top temperature of the exothermic peak observed on the lowermost temperature side when the electrolyte precursor contained in the fluid is subjected to differential thermal analysis (DTA) under a temperature rising condition of 10° C./minute with a differential thermal analyzer (DTA apparatus)), which is used as the base point, plus preferably 5° C. or higher, more preferably 10° C. or higher, and still more preferably 20° C. or higher, and the upper limit is not particularly limited, and may be set to the base point plus about 40° C. or lower. When the heating temperature is set within such a temperature range, a crystalline solid electrolyte is more efficiently and reliably obtained.

In the production method of the present embodiment, the heating temperature for obtaining a crystalline sulfide solid electrolyte can vary depending on the crystallization temperature determined according to the structure of the crystalline solid electrolyte to be obtained as described above, and therefore cannot be defined unconditionally. However, for example, when the crystalline solid electrolyte of the present embodiment is obtained, since the crystalline sulfide solid electrolyte of the present embodiment has a thio-LISICON Region II-type crystal structure as a basic structure, the heating temperature can be set in consideration of the temperature at which the thio-LISICON Region II-type crystal structure is crystallized. The heating temperature in this case is generally preferably 130° C. or higher, more preferably 135° C. or higher, and still more preferably 140° C. or higher, and the upper limit is not particularly limited, but is preferably 300° C. or lower, more preferably 280° C. or lower, and still more preferably 250° C. or lower.

Further, a crystalline sulfide solid electrolyte may be obtained by heating an electrolyte precursor or the like to obtain an amorphous sulfide solid electrolyte, and then heating the obtained amorphous sulfide solid electrolyte. A crystalline sulfide solid electrolyte with a higher quality is obtained.

The heating temperature in the case of obtaining an amorphous solid electrolyte may be set within the range of the temperature at which the crystalline sulfide solid electrolyte to be obtained is crystallized, which is used as the base point, plus preferably 5° C. or lower, more preferably 10° C. or lower, and still more preferably 20° C. or lower, and the lower limit is not particularly limited, but may be set to the peak top temperature of the exothermic peak observed on the lowermost temperature side minus about 40° C. or higher. When the heating temperature is set within such a temperature range, an amorphous solid electrolyte is more efficiently and reliably obtained.

The heating temperature for obtaining an amorphous solid electrolyte can vary depending on the structure of the crystalline solid electrolyte to be obtained, and therefore cannot be defined unconditionally. However, for example, when the crystalline solid electrolyte of the present embodiment is obtained, the heating temperature is generally preferably 135° C. or lower, more preferably 130° C. or lower, and still more preferably 125° C. or lower, and the lower limit is not particularly limited, but preferably 50° C. or higher, more preferably 70° C. or higher, still more preferably 80° C. or higher, even more preferably 100° C. or higher, and particularly preferably 110° C. or higher.

The heating time is not particularly limited as long as a desired crystalline sulfide solid electrolyte or amorphous sulfide solid electrolyte is obtained, but is, for example, preferably 1 minute or more, more preferably 10 minutes or more, still more preferably 30 minutes or more, and even more preferably 1 hour or more. The upper limit of the heating time is not particularly limited, but is preferably 24 hours or less, more preferably 10 hours or less, still more preferably 5 hours or less, and even more preferably 3 hours or less.

Further, the heating is preferably performed in an inert gas atmosphere (for example, a nitrogen atmosphere or an argon atmosphere) or a reduced pressure atmosphere (particularly in vacuum). This is because deterioration (for example, oxidation) of the crystalline solid electrolyte can be prevented. The heating method is not particularly limited, and examples thereof include methods using a hot plate, a vacuum heater, an argon gas atmosphere furnace, and a heating furnace. Further, industrially, a horizontal dryer, a horizontal vibrating fluidized dryer, or the like having a heating unit and a feeding mechanism can also be used, and may be selected depending on the amount to be treated by heating.

### (Amorphous Sulfide Solid Electrolyte)

In the production method of the present embodiment, the amorphous sulfide solid electrolyte to be obtained as an intermediate contains a lithium atom, a phosphorus atom, a sulfur atom, and a halogen atom. Preferred representative examples thereof include solid electrolytes formed of lithium sulfide, phosphorus sulfide, and a lithium halide such as Li₂S—P₂S₅—LiI, Li₂S—P₂S₅—LiBr, and Li₂S—P₂S₅—LiI—LiBr; and solid electrolytes further containing another atom such as an oxygen atom or a silicon atom such as Li₂S—P₂S₅—Li₂O—LiI and Li₂S—SiS₂—P₂S₅—LiI. From the viewpoint of obtaining a higher ionic conductivity, solid electrolytes formed of lithium sulfide, phosphorus sulfide, and a lithium halide such as Li₂S—P₂S₅—LiI, Li₂S—P₂S₅—LiBr, and Li₂S—P₂S₅—LiI—LiBr are preferably exemplified.

The types of atoms forming the amorphous solid electrolyte can be checked, for example, by an ICP optical emission spectrometer.

### (Crystalline Sulfide Solid Electrolyte)

Examples of the crystalline sulfide solid electrolyte obtained by the production method of the present embodiment include the crystalline sulfide solid electrolyte having a thio-LISICON Region II-type crystal structure as a basic structure of the present embodiment described above. That is, the crystalline sulfide solid electrolyte of the present embodiment is suitably obtained by the production method of the present embodiment.

Further, the crystalline solid electrolyte obtained by the production method of the present embodiment may be a so-called glass ceramic obtained by heating an amorphous solid electrolyte to a crystallization temperature or higher. Examples of a crystal structure thereof include an Li₃PS₄ crystal structure, an Li₄P₂S₆ crystal structure, an Li₇PS₆ crystal structure, an Li₇P₃S₁₁ crystal structure, and a crystal structure having peaks at around 2θ=20.2° and 23.6° (see, for example, JP 2013-16423 A).

The shape of the crystalline sulfide solid electrolyte is not particularly limited, and examples thereof include a particulate shape. The average particle diameter (D₅₀) of the crystalline solid electrolyte in a particulate shape can be, for example, within the range of 0.01 μm to 500 μm or 0.1 to 200 μm.

### EXAMPLES

Next, the present invention will be specifically described with reference to Examples, but the present invention is by no means limited to the Examples.

### (Powdery X-Ray Diffractometry)

The powdery X-ray diffractometry (XRD) was performed as follows.

A powder of a solid electrolyte in each example was placed into a groove having a diameter of 25 mm and a depth of 1 mm and leveled with a glass to prepare a sample. This sample was subjected to measurement under the following conditions without contact with air using an airtight sample holder.

Measurement apparatus: D2 PHASER, manufactured by Bruker Co., Ltd.
Tube voltage: 30 kV
Tube current: 10 mA
X-ray wavelength: Cu-Kα ray (1.5418 A)
Optical system: focusing method
Slit configuration: solar slit 4°, divergence slit 1 mm, Kβ filter (Ni plate) used
Detector: semiconductor detector
Measurement range: 2θ=10 to 60 deg
Step width, scan speed: 0.02 deg, 0.02 deg/sec

The peak intensity and the half width were calculated by the following method.

A range of the maximum peak±0.5° is used. A proportion of Lorentz function is represented by A (0≤A≤1), a peak intensity with the background corrected is represented by B, a maximum peak at 2θ is represented by C, a peak position in a range (C±0.5°) to be used for calculation is represented by D, a half width parameter is represented by E, a background is represented by F, and each peak intensity in the peak range to be used for calculation is represented by G, and the following calculation is performed at each peak position when the variables are A, B, C, D, E, and F.

$$H = G - \{ B \times \{ A / ( 1 + {( D - C )}^{2} / {E}^{2} ) + ( 1 - A ) \times exp ( - 1 \times {( D - C )}^{2} / {E}^{2} ) \} + F \}$$

H's were summed within the range of the peak C±0.5° to be calculated, and the peak intensity was determined by GRG nonlinear minimization of the sum with the Solver function of a spreadsheet software Excel (Microsoft Corporation).

The half width was calculated as a Gaussian function.

### (Measurement of Ionic Conductivity)

In Examples herein, the ionic conductivity was measured as follows.

A circular pellet having a diameter of 10 mm (cross-sectional area S: 0.785 cm²) and a height (L) of 0.1 to 0.3 cm was molded from the crystalline solid electrolyte obtained in each of Examples and Comparative Example, and used as a sample. Electrode terminals were led from the top and the bottom of the sample, and measurement was performed at 25° C. by an AC impedance method (frequency range: 5 MHz to 0.5 Hz, amplitude: 10 mV) to obtain a Cole-Cole plot. In the vicinity of the right end of an arc observed in a region on the high frequency side, a real number part Z′ (Ω) at a point at which −Z″ (Ω) is the smallest was defined as a bulk resistance R (Ω) of the electrolyte, and the ionic conductivity σ (S/cm) was calculated according to the following formulae.

$$\begin{matrix}R = ρ ( L / S ) \\ σ = 1 / ρ\end{matrix}$$

### Production Example 1

Into a Schlenk with a stirring bar (capacity: 5,000 mL), 478.5 g of lithium sulfide (Li₂S) was introduced as a solid electrolyte raw material in a nitrogen atmosphere. After the stirring bar was rotated, 4,000 mL of cyclohexane was added, then 188.8 g of iodine (I₂) was added as a solid electrolyte raw material, and the mixture was stirred at room temperature for 2 hours. Thereafter, 118.9 g of bromine (Br₂) was added as a solid electrolyte raw material, and the mixture was stirred at room temperature for 12 hours and then further stirred at 60° C. for 3 hours. This slurry was allowed to stand to precipitate the solid content, and after 2,000 mL of the supernatant was removed, 2,000 mL of cyclohexane was added. This decantation was performed three times to obtain a cyclohexane slurry containing lithium sulfide, lithium iodide, and lithium bromide.

### Production Example 2: Production of Li₃PS₄-TMEDA Complex

In an inert gas atmosphere in a glove box, a total of 10 g of lithium sulfide (Li₂S) and diphosphorus pentasulfide (P₂S₅) were weighed in a Schlenk bottle with a stirring bar so that the molar ratio was 3:1, and the mixture was cooled with an acetone-liquid nitrogen mixed liquid. After cooling for 30 minutes, while stirring with the stirring bar, 100 mL of tetrahydrofuran (THF) was added under an inert gas flow, and the mixture was further stirred for 3 days. The obtained slurry was filtered, the obtained solid was washed five times with THF, and the solvent was vacuum-dried to obtain a Li₃PS₄-3THF complex. This complex was vacuum-dried at 90° C. for 5 hours to obtain amorphous g-Li₃PS₄. In a glove box, 5 g of the obtained g-Li₃PS₄ was weighed in a Schlenk bottle with a stirring bar in an inert gas atmosphere, and 20 mL of N,N,N,N-tetramethylethane-1,2-diamine (tetramethylethylenediamine, TMEDA) was added under an inert gas flow, followed by stirring. After 3 days of the reaction, the solvent was vacuum-dried (at room temperature) to obtain a Li₃PS₄-TMEDA complex.

### Production Example 3: Production of LiI-TMEDA Complex

A LiI-TMEDA complex was produced in the same manner as in the above Production Example 2 except that, in the above Production Example 2, 5 g of LiI was weighed in place of g-Li₃PS₄, the solvent was vacuum-dried (at room temperature), and then a drying treatment was performed at 100° C.

### Example 1

To the slurry containing lithium sulfide, lithium iodide, and lithium bromide obtained in Production Example 1, 661.4 g of diphosphorus pentasulfide (P₂S₅) and 24 L of cyclohexane were added, and the mixture was transferred to a 35 L reaction vessel with a circulation line including a rotor blade. To the reaction vessel, 3.1 L of tetramethylethylenediamine (complexing agent 1) was added, and mixing (first mixing) by circulation stirring was started at room temperature at a rotor blade rotation speed of 80 rpm and a pump flow rate of 3 L/min. After 72 hours, 1.8 L (an amount corresponding to a molar ratio of 3 with respect to the expected amount of Li₃PS₄ to be obtained from the above raw materials) of 1,2-dimethoxyethane (complexing agent 2, hereinafter also referred to as “DME”) was added, and mixing (second mixing) was performed by continuing circulation stirring for another 48 hours to obtain a fluid (slurry).

Subsequently, a fluidized drying apparatus including a medium fluidized dryer and a bag filter having the configuration shown in FIG. 1 was used, the supply temperature of a gas to the fluidized dryer was set to 90° C., the supply rate was set to 2.4 m/s (the supply rate at 90° C. with respect to the cross section (diameter: 98 mm) of the fluidized bed of the medium (media particles)), and the fluid (slurry) obtained by the second mixing was supplied so that the temperature of the fluid containing a gas and a powder extracted from the top of the medium fluidized dryer was 70° C. As the media particles as the medium, ceramic particles with a particle diameter of 2 mm were used, and the filling rate of the ceramic particles was set to 30% by volume with respect to the volume of the medium fluidized dryer. Further, nitrogen was used as the gas for fluidizing the media particles serving as the medium.

After the operation of the medium fluidized dryer entered a steady state, drying was continuously performed for 48 hours, and the powder (electrolyte precursor) collected by the bag filter was recovered. The recovered powder was heated at a heating temperature of 110° C. under vacuum for 2 hours to obtain an amorphous sulfide solid electrolyte. Further, the amorphous sulfide solid electrolyte was heated at 180° C. for 2 hours under vacuum to obtain a crystalline sulfide solid electrolyte.

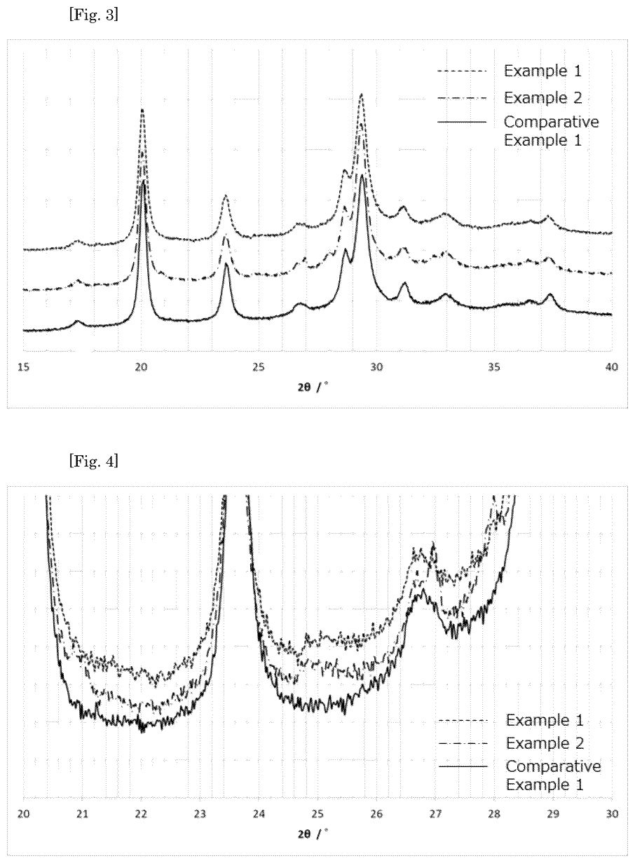

The obtained crystalline sulfide solid electrolyte was subjected to XRD measurement. The result is shown in FIG. 3. Further, an enlarged view centered on 2θ=25.0° is shown in FIG. 4. In the X-ray diffraction spectrum of the crystalline solid electrolyte, crystallization peaks were detected mainly at 2θ=20.2° and 23.6°, and therefore it was verified that the crystalline sulfide solid electrolyte has a thio-LISICON Region II-type crystal structure as a basic structure. It was also verified that the crystalline sulfide solid electrolyte has a diffraction peak at 2θ=25.0°, and does not have diffraction peaks at 2θ=17.5° and 26.1° (that is, does not have crystalline Li₃PS₄ (β-Li₃PS₄)).

The ionic conductivity was measured, and found to be 4.4×10⁻³ (S/cm), and it was verified that the crystalline sulfide solid electrolyte has a high ionic conductivity. Further, the peak intensities at 2θ=23.5° and 25.0° obtained from the result of the above XRD measurement and the ratio thereof, as well as the half widths of these diffraction peaks are shown in Table 1.

### Example 2

A crystalline sulfide solid electrolyte was obtained in the same manner as in Example 1 except that, in Example 1, cyclohexane used in the first mixing was changed to n-heptane.

The obtained crystalline sulfide solid electrolyte was subjected to XRD measurement. The result is shown in FIG. 3. Further, an enlarged view centered on 2θ=25.0° is shown in FIG. 4. In the X-ray diffraction spectrum of the crystalline solid electrolyte, crystallization peaks were detected mainly at 2θ=20.2° and 23.6°, and therefore it was verified that the crystalline sulfide solid electrolyte has a thio-LISICON Region II-type crystal structure as a basic structure. It was also verified that the crystalline sulfide solid electrolyte has a diffraction peak at 2θ=25.0°, and does not have diffraction peaks at 20=17.5° and 26.1° (that is, does not have crystalline Li₃PS₄ (β-Li₃PS₄)).

The ionic conductivity was measured, and found to be 4.1×10⁻³ (S/cm), and it was verified that the crystalline sulfide solid electrolyte has a high ionic conductivity. The result is shown in Table 1. Further, the peak intensities at 20=23.5° and 25.0° obtained from the result of the above XRD measurement and the ratio thereof, as well as the half widths of these diffraction peaks are shown in Table 1.

### Comparative Example 1

In Example 1, after the first mixing was performed, the fluid (slurry) obtained by the first mixing was connected to a bead mill machine (“LME4 (model number)”, manufactured by Ashizawa Finetech Ltd., filled with 8.7 kg of zirconia beads having a diameter of 0.5 mm), and subjected to pulverization mixing for 4 hours using the bead mill under the conditions of a pump flow rate of 2 L/min and a bead mill peripheral speed of 12 m/sec to obtain a fluid (slurry). Subsequently, a powder was obtained in the same manner as in Example 1 using a fluidized drying apparatus including a medium fluidized dryer and a bag filter having the configuration shown in FIG. 1.

The obtained powder was subjected to XRD measurement. The result is shown in FIG. 3. Further, an enlarged view centered on 2θ=25.0° is shown in FIG. 4. In the X-ray diffraction spectrum of the powder of Comparative Example 1, crystallization peaks were detected mainly at 2θ=20.2° and 23.6°, and therefore it was verified that the powder has a thio-LISICON Region II-type crystal structure as a basic structure. However, the powder does not have a diffraction peak at 2θ=25.0°, and therefore it was verified that the powder does not have an argyrodite-type crystal structure. It was also verified that the powder does not have diffraction peaks at 2θ=17.5° and 26.10 (that is, does not have crystalline Li₃PS₄ (β-Li₃PS₄)).

The ionic conductivity was measured, and found to be 4.0×10⁻³ (S/cm), and it was verified that the powder is inferior to the crystalline solid electrolytes of Examples. The result is shown in Table 1. Further, the peak intensities at 20=23.5° and 25.0° obtained from the result of the above XRD measurement and the ratio thereof, as well as the half widths of these diffraction peaks are shown in Table 1.

TABLE 1

| | | | | Comparative |
|---|---|---|---|---|
| | | Example | | Example |
| | | 1 | 2 | 1 |
| First mixing | Complexing agent 1 | TMEDA | TMEDA | TMEDA |
| | Solvent | cyc-HEX | n-HEP | cyc-HEX |
| Second mixing | Complexing agent 2 | DME | DME | — |
| With or without pulverization | — | without | without | with |
| Drying method | — | Fluidized | Fluidized | Fluidized |
| | | drying | drying | drying |
| Ionic conductivity | mS/cm | 4.4 | 4.1 | 4.0 |
| half width Δ2θ_{23.5} | ° | 0.56 | 0.56 | 0.50 |
| half width Δ2θ_{25.0} | ° | 1.1 | 1.1 | — |
| XRD peak intensity I_{23.5} | — | 4508 | 4528 | 5708 |
| XRD peak intensity I_{25.0} | — | 228 | 257 | — |
| Peak intensity ratio I_{25.0}/I_{23.5} | — | 0.0506 | 0.0568 | — |

* Abbreviations in the table are as follows.
TMEDA: tetramethylethylenediamine
cyc-HEX: cyclohexane
n-HEP: heptane
DME: dimethoxyethane

### INDUSTRIAL APPLICABILITY

The crystalline sulfide solid electrolyte of the present embodiment has a high ionic conductivity, and therefore is suitably used for a battery, especially for a battery for use in information-related devices, communication devices, and so on, such as personal computers, video cameras, and mobile phones.

1: A crystalline sulfide solid electrolyte, comprising a lithium atom, a phosphorus atom, a sulfur atom, and at least either one halogen atom of a bromine atom and an iodine atom, wherein
the crystalline sulfide solid electrolyte has a diffraction peak at 2θ=25.0±0.5° in X-ray diffractometry using a CuKα ray, and has a thio-LISICON Region II-type crystal structure as a basic structure.

2: The crystalline sulfide solid electrolyte according to claim 1,
which does not contain a chlorine atom.

3: The crystalline sulfide solid electrolyte according to claim 1, wherein the halogen atom includes an iodine atom.

4: The crystalline sulfide solid electrolyte according to claim 1, wherein the halogen atom includes a bromine atom and an iodine atom.

5: The crystalline sulfide solid electrolyte according to claim 1, wherein a half width Δ2θ_{25.0} of the diffraction peak at 2θ=25.0±0.5° is larger than a half width Δ2θ_{23.5} of a diffraction peak at 2θ=23.5±0.5°.

6: A method for producing a crystalline sulfide solid electrolyte, the method comprising:
mixing a raw material-containing material containing a lithium atom, a phosphorus atom, a sulfur atom, and at least either one halogen atom of a bromine atom and an iodine atom with a complexing agent 1 in (1) below in a first mixing;
subsequently mixing with a complexing agent 2 in (2) below in a second mixing; and
drying by contact with a medium in an instant drying:
(1) a complexing agent 1 that is capable of forming Li₃PS₄ and a complex containing the halogen atom; and
(2) a complexing agent 2 that is other than the complexing agent 1 and is capable of forming a complex containing Li₃PS₄.

7: The method for producing a crystalline sulfide solid electrolyte according to claim 6, wherein the drying by contact with a medium is performed by at least one drying selected from the group consisting of fluidized drying using media particles as the medium, drying with a spray dryer, and airflow drying.

8: The method for producing a crystalline sulfide solid electrolyte according to claim 6, wherein the complexing agent 1 is a solvent containing a nitrogen atom.

9: The method for producing a crystalline sulfide solid electrolyte according to claim 6, wherein the complexing agent 2 is a solvent containing an oxygen atom.

10: The method for producing a crystalline sulfide solid electrolyte according to claim 6, wherein a number of moles of the complexing agent 1 used with respect to a total number of moles of lithium atoms contained in the raw material-containing material is 0.1 or more and 2.0 or less.

11: The method for producing a crystalline sulfide solid electrolyte according to claim 6, wherein a number of moles of the complexing agent 2 used with respect to a total number of moles of Li₃PS₄ produced from the raw material-containing material is 0.1 or more and 5.0 or less.

12: The method for producing a crystalline sulfide solid electrolyte according to claim 6, wherein the raw material-containing material contains lithium sulfide and diphosphorus pentasulfide.

13: The method for producing a crystalline sulfide solid electrolyte according to claim 6, wherein the raw material-containing material contains at least one selected from the group consisting of bromine, iodine, lithium bromide, and lithium iodide.

14: The method for producing a crystalline sulfide solid electrolyte according to claim 6, wherein the crystalline sulfide solid electrolyte contains a lithium atom, a phosphorus atom, a sulfur atom, and at least either one halogen atom of a bromine atom and an iodine atom, has a diffraction peak at 2θ=25.0±0.5° in X-ray diffractometry using a CuKα ray, and has a thio-LISICON Region II-type crystal structure as a basic structure.
